(19) United States
(12) Patent Application Publication
(10) Pub. No.: US 2026/0325401 A1
(43) Pub. Date: Oct. 22, 2026

(54) COMPRESSION POSITION FEEDBACK AND ADJUSTMENT

(71) Applicant: Stryker Corporation, Portage, MI (US)

(72) Inventors: Kristian Solem, Trelleborg (SE); Olibhéar McAlister, Belfast (GB); Tyson G. Taylor, Bothell, WA (US)

(73) Assignee: Stryker Corporation, Portage, MI (US)

(21) Appl. No.: 19/468,412

(22) Filed: Feb. 3, 2026

Related U.S. Application Data
(60) Provisional application No. 63/755,833, filed on Feb. 7, 2025.
(60) Provisional application No. 63/868,220, filed on Aug. 21, 2025.

(51) Int. Cl. A61H 31/00

(52) U.S. Cl. CPC A61H 31/005; A61H 31/006; A61H 31/008; A61H 2201/5043; A61H 2230/04

(57) ABSTRACT

CPR systems and/or CPR devices that are configured to dynamically change, and/or cause output of a feedback signal(s) relating to, a compression position during CPR treatment are disclosed. An example CPR system includes a processor(s) and a sensor(s), the sensor(s) configured to sense a parameter associated with a subject as chest compressions are being administered to the subject. The processor(s) is configured to determine, by analyzing the parameter sensed by the sensor, that a heart valve of the subject is not functioning, and, in response to determining that the heart valve of the subject is not functioning, cause a feedback signal to be output as feedback to change a position on a chest of the subject at which future chest compressions are to be administered to the subject and/or cause a chest compressing mechanism to change the compression position automatically.

### CROSS-REFERENCE TO RELATED APPLICATIONS

This application claims the benefit of U.S. Provisional Application No. 63/868,220, titled “COMPRESSION POSITION FEEDBACK AND ADJUSTMENT” and filed on Aug. 21, 2025, and the benefit of U.S. Provisional Application No. 63/755,833, titled “COMPRESSION POSITION FEEDBACK AND ADJUSTMENT” and filed on Feb. 7, 2025. U.S. Provisional Application Nos. 63/868,220 and 63/755,833 are incorporated by reference herein in their entirety.

### BACKGROUND

During cardiac arrest, when a subject's heart stops beating or beats too ineffectively to circulate blood to the brain and other vital organs, cardiopulmonary resuscitation (CPR) can be an effective treatment that saves the life of the subject, if performed properly. CPR involves administering repeated chest compressions to the chest of the subject, which causes blood to circulate through the body of the subject. Historically, CPR has been performed manually by a rescuer placing their hands on the chest of the subject and repeatedly applying a downward force to the chest. However, the efficacy of manual CPR is dependent upon rescuers being trained to administer high quality CPR.

To help ensure that CPR is administered properly on a more consistent basis, and to alleviate some of the burden on rescuers at a rescue scene, various CPR systems have been developed. One example of an existing CPR system is a mechanical chest compression device (also known as a “mechanical CPR device”) that administers automated chest compressions to a subject. Two types of mechanical chest compression devices in use today include piston-based devices, which utilize a piston to compress the subject's chest, and vest-based devices, which utilize a load-distributing band to compress the subject's chest. Another example of a CPR system is a CPR feedback system, which may utilize a device placed on the subject's chest to monitor the chest compressions that a rescuer is manually administering to the subject, and to facilitate the provisioning of real-time feedback to the rescuer to adjust their technique, as needed.

### BRIEF DESCRIPTION OF THE DRAWINGS

FIG. 1 illustrates an environment including an example mechanical chest compression device that is configured to administer CPR treatment to a subject. FIG. 1 also illustrates components that are configured to dynamically change, or cause a feedback signal to be output as feedback for a rescuer to change, a position on a chest of the subject at which future chest compressions are to be administered to the subject.

FIG. 2 illustrates an environment including an example CPR feedback system that is configured to provide feedback for a rescuer to change a position on a chest of a subject at which future chest compressions are to be administered to the subject.

FIG. 3 illustrates the example mechanical chest compression device depicted in FIG. 1, FIG. 3 depicting various example components of the mechanical chest compression device to, among other things, record sounds (e.g., internal body sounds, environment sounds, etc.) and to output a feedback signal(s) relating to compression position.

FIG. 4 illustrates the example CPR feedback device depicted in FIG. 2, FIG. 4 depicting various example components of the CPR feedback device to, among other things, record sounds (e.g., internal body sounds, environment sounds, etc.) and to output a feedback signal(s) relating to compression position.

FIG. 5 illustrates a time of aortic valve closure exhibited in a blood pressure signal.

FIG. 6 illustrates a time of aortic valve closure exhibited in an ultrasound signal.

FIG. 7 illustrates a time of aortic valve closure exhibited in a photoplethysmography (PPG) signal.

FIG. 8 illustrates a time of aortic valve closure exhibited in an audio sound signal.

FIG. 9 illustrates an example process for analyzing a parameter(s) indicative of heart valve function of a subject as the subject is receiving CPR treatment, and dynamically changing, and/or causing output of a feedback signal relating to, a compression position based at least in part on the parameter analysis.

FIG. 10 illustrates a compression and decompression profile (or, “waveform”) that includes period of time with reduced noise during which a heart sound can be detected.

FIG. 11 illustrates an example process for detecting a heart sound at a particular time during a compression-decompression cycle to mitigate noise during the detection of the heart sound, analyzing the detected heart sound to determine whether a heart valve of a subject is functioning, and dynamically changing, and/or causing output of a feedback signal relating to, a compression position based at least in part on the heart sound analysis.

FIG. 12 illustrates an example process for filtering an audio signal representing a heart sound to remove unwanted noise from the audio signal, analyzing the filtered audio signal to determine whether a heart valve of a subject is functioning, and dynamically changing, and/or causing output of a feedback signal relating to, a compression position based at least in part on the analysis of the filtered audio signal.

FIG. 13 illustrates an example process for identifying return of spontaneous circulation (ROSC) in a subject based on analyzing an audio signal.

FIG. 14 illustrates example heart valve sounds and breath sounds.

FIG. 15 illustrates an example external defibrillator configured to perform various functions described herein.

FIG. 16 illustrates an example mechanical chest compression device configured to perform various functions described herein.

FIG. 17 illustrates audio signals generated during administration of CPR to a subject by a mechanical chest compression device, the audio signals including a first audio signal generated using an auscultation device(s) disposed on a thorax of the subject, and a second audio signal generated using a microphone(s) in an environment of the subject.

FIG. 18A illustrates an arterial blood pressure curve associated with a cardiac arrest patient during administration of CPR to the patient.

FIG. 18B illustrates another arterial blood pressure curve associated with a cardiac arrest patient during administration of CPR.

### DETAILED DESCRIPTION

Various implementations described herein relate to cardiopulmonary resuscitation (CPR) systems and/or CPR devices that are configured to dynamically change, and/or cause output of a feedback signal(s) relating to, a compression position during CPR treatment. As used herein, “compression position” means a position on a chest of a subject at which chest compressions were, are being, or are going to be administered. Existing mechanical chest compression devices are configured to administer automated chest compressions at compression depths and compression rates consistent with CPR guidelines. However, the administration of automated chest compressions at the correct position on the chest of the subject using existing mechanical chest compression devices is dependent upon a rescuer being trained to properly position the mechanical chest compression device on the subject and/or to know when to manually adjust the compression position, as needed. Similarly, existing CPR feedback systems are configured to provide feedback to a rescuer relating to compression depth and compression rate. However, the administration of manual chest compressions at the correct position on the chest of the subject is dependent upon a rescuer being trained to properly position their hands on the subject and/or to know when to adjust their hand placement. While some existing CPR feedback systems utilize visual indicia (e.g., printed symbols, text, etc.) on the CPR feedback device itself to help a rescuer determine where on the chest of the subject to place their hands, this approach is prone to error since a rescuer may improperly position the CPR feedback device on the chest of the subject, and, hence, their hand placement may be incorrect.

Correct compression position is an important factor for high quality CPR. If the compression position is incorrect during the administration of CPR, the atrioventricular (AV) plane of the subject may be compressed. If the AV plane is compressed, the subject's aortic valve will not close completely during the compression phase of a compression-decompression cycle, leading to backflow of blood into the heart through the aorta at the end of the compression phase. This backflow of blood at the end of the compression phase significantly reduces cardiac output, resulting in an overall reduction in the quality of CPR because blood will not circulate adequately through the body of the subject. Low quality CPR due to incorrect compression position reduces the survival rate of cardiac arrest patients. In fact, rescuers may falsely believe that high quality CPR is being administered in instances where the compression position is incorrect due to existing CPR systems providing a false sense of high CPR quality through positive feedback signals indicating that compression depth and compression rate are within guidelines.

Implementations of the present disclosure address these and other problems through CPR systems and/or CPR devices that are configured to dynamically change, and/or cause output of a feedback signal(s) relating to, a compression position during CPR treatment. An example CPR system configured to implement the techniques described herein includes a processor(s) and a sensor(s), the sensor(s) being configured to sense a parameter(s) associated with a subject as chest compressions are being administered to the subject. The processor(s) of the CPR system is configured to determine, by analyzing the parameter(s) sensed by the sensor(s), that a heart valve of the subject is not functioning, and in response to determining that the heart valve of the subject is not functioning, cause a feedback signal(s) to be output as feedback to change a position on a chest of the subject at which future chest compressions are to be administered to the subject. In some examples, the CPR system includes a mechanical chest compression device with a chest compressing mechanism configured to be disposed on the chest of the subject and to administer automated chest compressions to the subject. In these examples, in lieu of, or in addition to, causing the feedback signal(s) to be output, the processor(s) may cause the chest compressing mechanism to change the compression position automatically (e.g., without user intervention) during the CPR treatment.

The determination as to whether the heart valve of the subject is functioning or not can be made in various ways, depending on the type of parameter(s) and/or the type of sensor(s) that sensed the parameter(s). The various ways of evaluating heart valve function are described in more detail below. One example way of evaluating heart valve function, as described herein, is by analyzing an audible heart sound parameter(s). For example, an audible heart sound signal may be obtained from an auscultation device(s)/sensor(s) (e.g., a microphone) attached to, and/or placed on or near, the skin surface of the thorax (e.g., the chest or the back) of the subject. During CPR, closure of the heart valves (if they close at all) may occur sequentially or simultaneously (or near simultaneously). The timing of the heart valves closing is a function of chamber filling volume and the pressure in the chamber and/or vessel in which the blood is ejected during the compression. For example, when there is right-ventricular distension, the pulmonary valve closing may create the first heart sound (of multiple heart sounds) exhibited in an audible heart sound signal. Therefore, during CPR, heart sounds may occur in a relatively normal sequence, in an abnormal sequence, or simultaneously. Moreover, the timing and/or the sequence of the heart sounds can provide insight into what the limiting factor might be to maximize blood flow in the body of the subject. Accordingly, in some examples, when the compression position is correct during the administration of CPR, two heart sounds may be exhibited in an audible heart sound signal during one compression-decompression cycle, and the latter of the two heart sounds may correspond to closure of the aortic valve. Thus, a reliable detection of the closing of the aortic valve may be obtained using, among other things, an audible heart sound signal captured using an auscultation device(s)/sensor(s) (e.g., a microphone) during CPR. By analyzing the audible heart sound parameter(s) representing the detected heart sound(s), the processor(s) can determine whether the aortic valve (or the pulmonary valve) of the heart of the subject closed completely during a compression phase of a compression-decompression cycle. For instance, during a latter portion of the compression phase during a compression-decompression cycle (e.g., shortly after a time at which a target compression depth is reached and the chest of the subject is held in the compressed state for a brief period of time), the aortic valve of the heart may close during this period in scenarios where the compression position is correct. In some examples, any heart sound corresponding to heart valve closure during a compression-decompression cycle may be indicative of a correct compression position. In some examples, a correlation between heart sounds and corresponding physiology may be determined and used to determine whether a heart valve is functioning or not and/or whether a compression parameter(s) (e.g., compression position, compression rate, compression depth, etc.) should be adjusted and, if so, how to adjust the compression parameter(s). If the processor(s) determines (e.g., based on the analysis of the audible heart sound parameter(s)) that the aortic valve or the pulmonary valve closed incompletely during the compression phase of a compression-decompression cycle, this determination may be taken as an indication that the compression position is incorrect or otherwise suboptimal. In some examples, the processor(s) is configured to confirm that a compression depth parameter(s) and a compression rate parameter(s) associated with the chest compressions are each within respective target value ranges before determining that the compression position is incorrect. In this way, the processor(s) can rule out that compression depth or compression rate is the cause of low quality CPR. In instances where the processor(s) determines that the compression position is incorrect, the processor(s) may cause a chest compressing mechanism (of a mechanical chest compression device) to dynamically change the compression position, and/or the processor(s) may cause output of a feedback signal(s) relating to compression position (e.g., feedback for the rescuer to change the compression position), thereby improving CPR quality through increased cardiac output.

In various implementations, a CPR system and/or a CPR device that is configured to dynamically change, and/or cause output of a feedback signal(s) relating to, a compression position during CPR treatment will improve the quality of CPR treatment administered using such CPR systems. This improvement of CPR quality is due to a reduction, if not an elimination, of blood backflow into the heart at the end of the compression phase of a compression-decompression cycle when the compression position is correct, which significantly increases cardiac output, resulting in improved blood circulation during CPR. High quality CPR due, in part, to correct compression position increases the survival rate of cardiac arrest patients. Moreover, with the techniques, devices, and systems described herein, rescuers can trust CPR systems to administer high quality CPR and/or to provide reliable feedback that can be trusted as an indication that high quality CPR is being administered. In addition, evaluating heart valve function as a proxy for correct compression position provides an automatic, reliable indication as to whether the compression position is correct or not during CPR treatment. For example, adequate blood circulation is typically monitored in out-of-hospital cardiac arrest (OHCA) patients by measuring an end-tidal carbon dioxide (EtCO₂) parameter associated with the subject. However, EtCO₂ is neither a reliable nor an automated measure of CPR quality. Moreover, in implementations where heart valve function is evaluated by analyzing an audible heart sound parameter(s), a CPR system can determine whether compression position is correct or not through a non-invasive detection of an audible heart sound signal, which exhibits an easy-to-detect heart sound indicative of aortic valve (or pulmonary valve) closure. In some examples, the timing of detecting a heart sound of the subject can be synchronized with a time period of a compression-decompression cycle when noise disturbances are reduced or non-existent, such as noise disturbances caused by the operation of one or more machines (e.g., a mechanical chest compression device, a ventilator, etc.) in the vicinity of the subject during particular time periods of the compression-decompression cycle. In this way, aortic valve (or pulmonary valve) closure can be detected with improved accuracy. In some examples, audio signals representing a heart sound can be filtered by removing noise from the audio signals (e.g., using active-noise-cancellation (ANC) and/or passive-noise cancellation), thereby enabling the detection of aortic valve (or pulmonary valve) closure in noisy environments.

Also described herein are CPR systems and/or CPR devices with one or more integrated microphones. The integrated microphone(s) can be used to record various sounds (e.g., internal body sounds of a subject receiving CPR treatment, environment sounds, etc.) for various purposes. One example purpose, as briefly described above, is to determine whether a compression position is correct or not, through the detection of a heart sound indicative of heart valve function (e.g., aortic valve closure and/or pulmonary valve closure) during CPR. In implementations where the CPR system includes a mechanical chest compression device, the microphone(s) can be used to detect an audible connection sound indicating that a pair of legs of the mechanical chest compression device have been connected to a backplate of the mechanical chest compression device. In this example, the legs are connected to the backplate when a rescuer is securing the mechanical chest compression device around a subject (e.g., around a thorax of the subject) in cardiac arrest, and the audible connection sound can be used as a reliable indicator that the legs are securely connected to the backplate so that the mechanical chest compression device remains securely positioned on and/or around the subject during a CPR session. In some examples, the microphone(s) can be used to record a monologue of a rescuer or a dialogue between multiple rescuers (or bystanders) at a rescue scene, which may be helpful for offline review of CPR quality, to record notes of a rescuer without the rescuer having to instruct an assistant to record hand-written notes in real-time, and/or the like. In some examples, the microphone(s) can be integrated into a defibrillator (e.g., an automated external defibrillator (AED)) and can be used to record and analyze heart sounds from a non-cardiac arrest patient, and in this example, the patient may have the opportunity to be diagnosed and treated in such a way that a potential future cardiac arrest on the patient may be avoided.

Various implementations will now be described with reference to the accompanying figures.

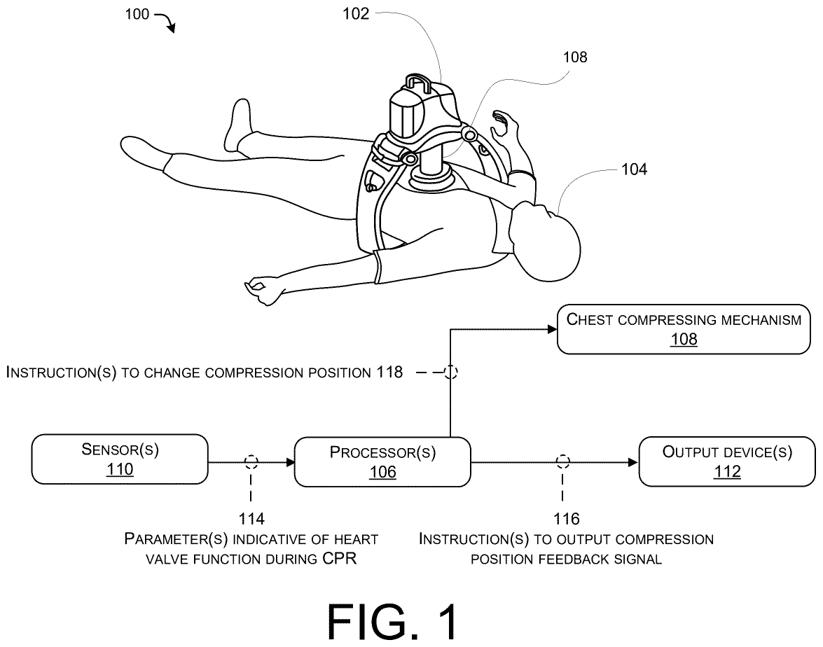

FIG. 1 illustrates an environment 100 including an example mechanical chest compression device 102 that is configured to administer a CPR treatment to a subject 104. In various cases, the environment 100 is in an out-of-hospital environment. For example, the subject 104 may have experienced a medical emergency in a non-hospital, public space, such as a library, airport terminal, school, or office building. In some cases, the subject 104 has collapsed or otherwise lost consciousness within the environment 100. In some examples, the subject 104 has experienced one or more other types of symptoms associated with a serious health condition (e.g., cardiac arrest). As a result, a bystander may have contacted emergency services personnel in order to assist the subject 104 and to transport the subject 104 to a clinical environment, if necessary.

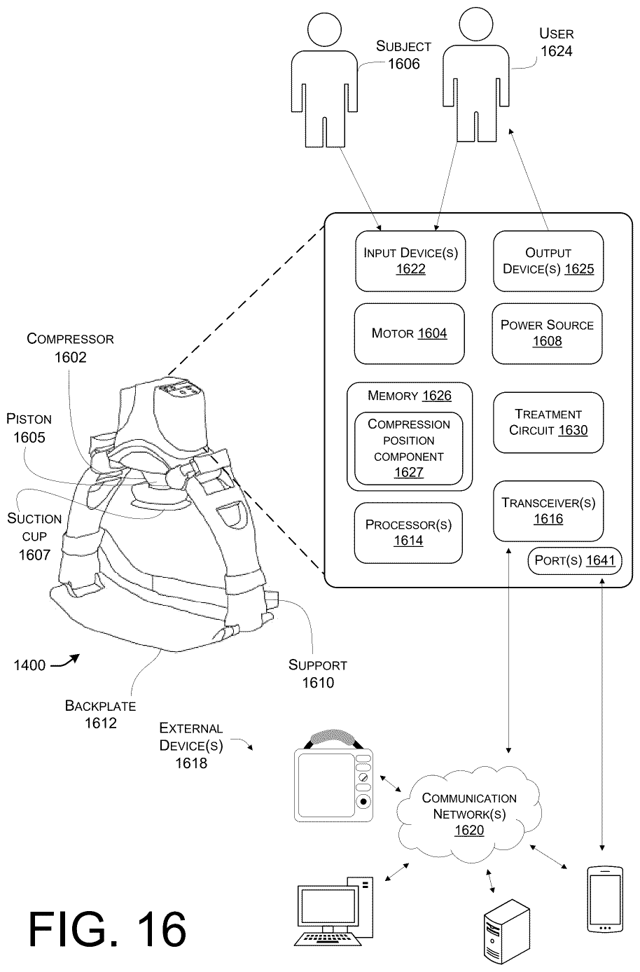

In various cases, a rescuer (not shown in FIG. 1) arrives at the rescue scene, secures the mechanical chest compression device 102 around the subject 104 (e.g., around a thorax thereof), and begins operating, and/or initiates autonomous operation of, the mechanical chest compression device 102. For example, the rescuer may provide input to the mechanical chest compression device 102 to set one or more chest compression parameters (e.g., compression rate, compression depth, etc.), and/or to start CPR treatment (e.g., autonomous chest compressions) via the mechanical chest compression device 102. Various example components of the mechanical chest compression device 102 shown in FIG. 1 are described in more detail below with respect to FIG. 16. In some examples, the mechanical chest compression device 102 includes a processor(s) 106, a chest compressing mechanism 108, a sensor(s) 110, and/or an output device(s) 112. The chest compressing mechanism 108 is configured to be disposed on a chest of the subject 104 and to move for administering chest compressions to the subject 104. The example mechanical chest compression device 102 shown in FIG. 1 is a piston-based device. Accordingly, the chest compressing mechanism 108 illustrated in FIG. 1 is in the form of a piston, the piston being movable bidirectionally between various positions relative to the frame of the mechanical chest compression device 102 and/or relative to the subject 104 (e.g., the chest compressing mechanism 108 is configured to move up and down relative to the chest of the subject 104 when the subject 104 is lying on their back in a horizontal orientation). It is to be appreciated, however, that other types of mechanical chest compression devices may implement the techniques described herein, such as vest-based devices where the chest compressing mechanism includes a load-distributing band disposed around the thorax of the subject 104.

In some examples, the sensor(s) 110 is integrated into the mechanical chest compression device 102. In some examples, the sensor(s) 110 is connected to the mechanical chest compression device 102 (e.g., communicatively connected via a wired and/or wireless communication interface(s). The sensor(s) 110 is configured to detect one or more physiological parameters of the subject 104. In some examples, such parameter(s) may include a blood pressure parameter(s), a blood flow parameter(s), a blood oxygenation parameter(s), airway parameter(s) (e.g., capnograph, EtCO₂), an ultrasound parameter(s) (e.g., a blood velocity derived using a Doppler probe), a photoplethysmography (PPG) parameter, an audible heart sound parameter(s), and/or other physiological parameters associated with the subject 104. As depicted in FIG. 1, a parameter(s) 114 sensed by the sensor(s) 110 may be indicative of heart valve function during CPR. That is, the parameter(s) 114 sensed by the sensor(s) 110 may be analyzed to determine that a heart valve of the subject 104 is functioning (or not functioning).

The processor(s) 106 of the mechanical chest compression device 102 is configured to cause the chest compressing mechanism 108 to move for administering chest compressions to the subject 104 over a series of compression-decompression cycles. In some examples, the processor(s) 106 is configured to execute computer-executable instructions stored in memory of the mechanical chest compression device 102 to control the movement of the chest compressing mechanism 108, as described herein. In some examples, the processor(s) 106 is configured to control the movement of the chest compressing mechanism in accordance with one or more settings of the mechanical chest compression device 102, which may be adjusted by a user (e.g., a rescuer at the rescue scene). Additionally, or alternatively, such settings may be initialized automatically (without user intervention) by the mechanical chest compression device 102 at a time at which the mechanical chest compression device 102 is initialized (e.g., powered on) and/or adjusted automatically (without user intervention) on-the-fly during CPR treatment. The settings of the mechanical chest compression device 102 may relate to various chest compression parameters, such as compression rate, compression depth, compression force, compression velocity, compression acceleration, one or more hold periods during the compression and/or decompression phases, the duty cycle of the mechanical chest compression device 102, active decompression height, compression position on the chest, and/or the like.

FIG. 1 also illustrates that one or more components of the mechanical chest compression device 102 are configured to dynamically change, or cause a feedback signal to be output as feedback for a rescuer to change, a position on a chest of the subject 104 at which future chest compressions are to be administered to the subject 104. That is, the mechanical chest compression device 102 is, in some examples, configured to dynamically change the compression position, and/or, in some examples, configured to output a feedback signal(s) relating to the compression position. For example, as the mechanical chest compression device 102 is administering automated chest compressions, the processor(s) 106 may analyze the parameter(s) 114 sensed by the sensor(s) 110 to determine whether a heart valve of the subject 104 is functioning or not (e.g., the heart in cardiac arrest is responding well to high quality CPR). In some examples, determining whether the heart valve is functioning involves determining that an aortic valve or a pulmonary valve of the heart closed completely during a compression phase of a compression-decompression cycle. Various techniques for evaluating heart valve function (e.g., through detection of aortic valve or pulmonary valve closure) are described in detail below.

In some examples, if the processor(s) 106 determines that the heart valve of the subject 104 is not functioning, the processor(s) 106 provides an instruction(s) 116 to the output device(s) 112, the instruction(s) causing the output device(s) 112 to output a feedback signal(s) as feedback to change the compression position (e.g., the position on a chest of the subject 104 at which future chest compressions are to be administered to the subject 104). The output device(s) 112 can be any suitable type of output device(s) including a display(s), a light emitting element(s) (e.g., a light emitting diode(s) (LED(s)), a speaker(s), a haptic actuator(s), and/or the like. In an example, the output device(s) 112 is an LED configured to emit light of various wavelengths or colors. In this example, to provide a visual feedback signal(s) as feedback to change the compression position, the LED may emit red-colored light, which may be a visual signal for a nearby rescuer to change the compression position (e.g., to change the placement of the chest compressing mechanism 108 on the chest of the subject 104 until the LED emits a green-colored light indicative of correct compression position). In some examples, if the processor(s) 106 determines that the heart valve of the subject 104 is functioning, the processor(s) 106 provides an instruction(s) 116 to the output device(s) 112, the instruction(s) causing the output device(s) 112 to output a feedback signal(s) as feedback indicating that the compression position is correct. In the LED example described above, the LED may emit a green-colored light, which may be a visual signal to the rescuer that the compression position is correct and does not need to be changed.

In some examples, if the processor(s) 106 determines that the heart valve of the subject 104 is not functioning, the processor(s) 106 provides an instruction(s) 118 to the chest compressing mechanism 108, the instruction(s) causing the chest compressing mechanism 108 to change the compression position (e.g., the position on a chest of the subject 104 at which future chest compressions are to be administered to the subject 104). United States Patent Application Publication Number 2022/0125676, which is incorporated by reference herein in its entirety, describes a mechanical chest compression device that is configured to adjust a location of the compression position. Accordingly, in implementations described herein where the mechanical chest compression device 102 is configured to dynamically change the compression position, any of the techniques, device, and systems described in United States Patent Application Publication Number 2022/0125676 may be used to implement the change in compression position.

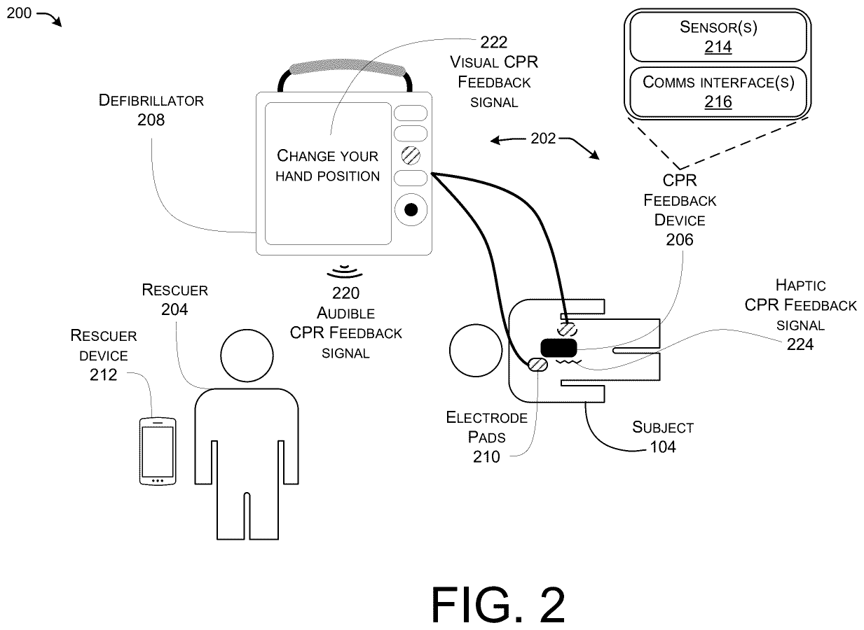

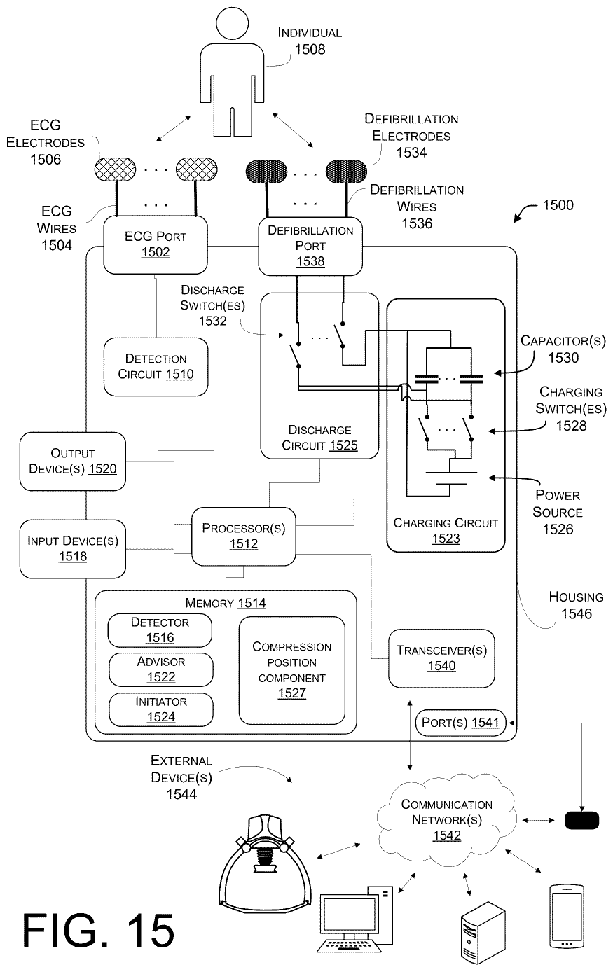

FIG. 2 illustrates an environment 200 including an example CPR feedback system 202 that is configured to provide feedback for a rescuer 204 to change the compression position (e.g., the position on a chest of a subject 104 at which future chest compressions are to be administered to the subject 104). In some examples, the CPR feedback system 202 includes a CPR feedback device 206 and/or a defibrillator 208. Various example components of the defibrillator 208 shown in FIG. 2 are described in more detail below with respect to FIG. 15. In some examples, the rescuer 204 operates the defibrillator 208 to monitor and potentially treat the subject 104. In some examples, the defibrillator 208 is a monitor-defibrillator, an automated external defibrillator (AED), or other defibrillator device. In some examples, the defibrillator 208 is designed for operation by users without specialized medical knowledge. In some examples, the rescuer 204 has specific medical expertise. For instance, the rescuer 204 is an emergency medical services (EMS) professional, a physician, a nurse, or some other individual with specific medical training.

In some examples, the defibrillator 208 instructs the rescuer 204 to apply electrode pads 210 to the skin of the subject 104. For example, the electrode pads 210 may be adhered to skin on the chest of the subject 104. In some examples, the CPR feedback device 206 is integrated into the electrode pads 210. For example, the electrode pads 210 may be mechanically coupled to the CPR feedback device 206 and used as an all-in-one accessory of the defibrillator 208. In some examples, the CPR feedback device 206 is separate from the electrode pads 210 (e.g., a standalone CPR feedback device 206).

The defibrillator 208 includes one or more detection circuits (See FIG. 15), or measurement circuit(s), configured to detect one or more physiological parameters of the subject 104. The detection circuit(s), for instance, is configured to be connected to one or more sensors that are applied to the body of the subject 104. The sensor(s), for instance, is configured to generate electrical signals that are indicative of the physiological parameter(s) of the subject 104. The detection circuit(s) may infer the physiological parameter(s) based on the electrical signals generated by the sensor(s).

In some examples, the electrode pads 210 include electrodes that are configured to detect an electrical signal output by the heart of the subject 104 over time. A detection circuit in the defibrillator 208, for instance, is configured to detect an electrocardiogram (ECG) of the subject 104 based on the electrical signal detected by the electrode pads 210.

In some examples, the CPR feedback system 202 includes the CPR feedback device 206 and a rescuer device 212. In some examples, the rescuer device 212 is a mobile phone, a tablet, a laptop computer, a smart watch, a head-mounted display (HMD), or any other suitable user device operable by the rescuer 204. In some examples, the CPR feedback system 202 includes the CPR feedback device 206, the defibrillator 208, and the rescuer device 212.

As shown in FIG. 2, the CPR feedback device 206 may include one or more sensors 214 and one or more communication interfaces 216. The communication interface(s) 216 may include one or more wired interfaces, one or more wireless interfaces, or a combination thereof. The communication interface(s) 216 configure the CPR feedback device 206 to communicate with (e.g., send signals, data, etc. to, and receive signals, data, etc. from) another device(s), such as the defibrillator 208 and/or the rescuer device 212. In some examples, the CPR feedback device 206 and the defibrillator 208 are configured to be wirelessly paired. Once paired, the CPR feedback device 206 is configured to communicate wirelessly with the defibrillator 208 over at least one wireless channel via the communication interface(s) 216. Additionally, or alternatively, the CPR feedback device 206 is configured to couple with the defibrillator 208 via one or more cables or wires, such as the cables that connect the electrode pads 210 to the defibrillator 208, and/or a separate cable(s) or wire(s). In this latter example, the CPR feedback device 206 is configured to communicate with the defibrillator 208 over the cable(s) or wire(s) via the communication interface(s) 216. In some examples, the CPR feedback device 206 and the rescuer device 212 are configured to be wirelessly paired or coupled via one or cables or wires in a similar fashion.

Various mechanisms can be utilized to pair the CPR feedback device 206 with the defibrillator 208 and/or the rescuer device 212. For example, automated pairing may involve the exchange of data and/or pairing requests/responses between the CPR feedback device 206 and the defibrillator 208 and/or between the CPR feedback device 206 and the rescuer device 212. As another example, the defibrillator 208 may receive an input signal from an operator (e.g., the rescuer 204) that selects the CPR feedback device 206 as a device to pair with the defibrillator 208, or vice versa. Similarly, the rescuer device 212 may allow an operator (e.g., the rescuer 204) to select the CPR feedback device 206 as a device to pair with the rescuer device 212, such as via an application (e.g., a CPR feedback application) executing on the rescuer device 212. In some cases, the defibrillator 208 and/or the rescuer device 212 detects an alternative signal (e.g., a flashing light pattern) from the CPR feedback device 206 that is indicated in a pairing request. In some cases, the defibrillator 208 and/or the rescuer device 212 is paired with the CPR feedback device 206 based, at least in part, on signaling to and/or from an intermediary device (not illustrated). In a particular example, two or more devices can be brought into proximity to (e.g., into contact with) each other in order to facilitating pairing (e.g., the defibrillator 208 with the CPR feedback device 206). For example, a “tap-to-pair” functionality may allow a user to bring the CPR feedback device 206 (or a component thereof) into close proximity to (e.g., into contact with) the defibrillator 208 (or a component thereof), or vice versa, and a short-range wireless protocol, such as BLUETOOTH™, near-field communication (NFC), or the like, may be used to detect that the defibrillator 208 and CPR feedback device 206 are within a threshold distance of each other, and, in response, the defibrillator 208 and the CPR feedback device 206 may be paired. In some cases, an intermediary device (e.g., the rescuer device 212) may be brought into close proximity to (e.g., into contact with) the defibrillator 208 and/or the CPR feedback device 206 (e.g., by touching the intermediary device to both the defibrillator 208 and the CPR feedback device 206 sequentially), and a short-range wireless protocol may be used to detect these proximity events involving the intermediary device, and, in response, the defibrillator 208 and the CPR feedback device 206 may be paired.

The sensor(s) 214 of the CPR feedback device 206 is configured to sense one or more parameters associated with the subject 104 and/or with the CPR treatment (e.g., chest compressions) that the rescuer 204 is manually administering to the subject 104. For example, the sensor(s) 214 may include one or more accelerometers, inertial measurement unit(s) (IMU(s)), gyroscopes, compasses, pressure sensor(s) (e.g., force sensing resistor(s) (FSR(s))), proximity sensor(s) (e.g., capacitive sensor(s)), auscultation device(s)/sensor(s), microphone(s), and/or other sensors that are configured to sense one or more parameter(s) associated with the subject 104 as the subject 104 is receiving CPR treatment. The parameter(s) sensed by the sensor(s) 214 can include a compression parameter(s) (e.g., compression rate, compression depth, compression force, compression velocity, compression acceleration, hand position on the chest, etc.), an audible heart sound parameter(s) (e.g., the opening and/or closing of valves of the heart of the subject 104, such as the aortic valve, the pulmonary valve, the mitral valve, etc.).

In some examples, sensor(s) are connected to the defibrillator 208 to detect one or more physiological parameters of the subject 104. In some examples, such physiological parameter(s) may include a blood pressure parameter(s) (e.g. obtained from an invasive blood pressure measurement and/or a non-invasive blood pressure measurement in which the parameter(s) may include the blood pressure values and/or the measurement signal itself), a blood flow parameter(s), a blood oxygenation parameter(s), an EtCO₂ parameter(s), an ultrasound parameter(s), a PPG parameter, an audible heart sound parameter(s), and/or other physiological parameters associated with the subject 104. In some examples, the sensor(s) 214 are directly connected to the defibrillator 208, and in this example, the sensor(s) 214 may not be included in the CPR feedback device 206, or alternatively the CPR feedback system 202 may exclude or omit the CPR feedback device 206, (e.g., the CPR feedback system 202 include the defibrillator 208 and no other devices). As described in more detail below, the defibrillator 208 and/or the rescuer device 212 may be configured to analyze one or more of these physiological parameters and/or one or more of the parameter(s) sensed by the sensor(s) 214 of the CPR feedback device 206 to determine whether a heart valve of the subject 104 is functioning or not (e.g., beating correctly or not). As noted above, in some examples, determining whether the heart valve is functioning involves determining that an aortic valve or a pulmonary valve of the heart closed completely during a compression phase of a compression-decompression cycle.

In some examples, if a processor(s) of the CPR feedback system 202 (e.g., a processor(s) of the defibrillator 208 (See FIG. 15), a processor(s) of the rescuer device 212, a processor(s) of the CPR feedback device 206, etc.) determines that the heart valve of the subject 104 is not functioning, the processor(s) causes a feedback signal(s) to be output as feedback to change the compression position (e.g., the position on a chest of the subject 104 at which future chest compressions are to be administered to the subject 104). In the example of FIG. 2, this feedback instructs the rescuer 204 to change the position on the chest at which their hands are placed for manually administering the chest compressions.

In some examples, the defibrillator 208 is configured to output a signal(s) as the feedback for the rescuer 204 to change the compression position (e.g., their hand placement on the chest of the subject 104). In some examples, the rescuer device 212 is configured to output a signal(s) as the feedback for the rescuer 204 to change the compression position. The signal(s) that is output as the feedback for the rescuer 204 may include an audible signal(s), a visual signal(s), and/or a haptic signal(s). FIG. 2 illustrates an example audible signal(s) 220 that may be output by the defibrillator 208 as feedback for the rescuer 204 to change the compression position. The audible signal(s) 220 may be output via a speaker(s) of the defibrillator 208. In some examples, the rescuer device 212 is configured to output a similar audible signal(s) 220 via a speaker(s) of the rescuer device 212. In some examples, the audible signal(s) 220 includes synthesized speech that provides verbal feedback (e.g., “change your hand position,” “try moving your hands to a different position on the chest,” etc.).

FIG. 2 further illustrates an example visual signal(s) 222 that may be output by the defibrillator 208 as feedback for the rescuer 204 to change the compression position. The visual signal(s) 222 may be output via a display(s) of the defibrillator 208, one or more light emitting elements (e.g., a LED(s)) of the defibrillator 208, and/or other output devices of the defibrillator 208. In some examples, the rescuer device 212 is configured to output a similar visual signal(s) 222 via a display(s) of the rescuer device 212. In some examples, the visual signal(s) 222 includes text (e.g., “change your hand position,” “try moving your hands to a different position on the chest,” etc.), a graphic, a picture, and/or a video showing correct hand placement pursuant to CPR guidelines, an arrow indicating a direction in which to move the hands (e.g., move the hands up, down, left, and/or right on the chest), and/or other types of visual signals.

FIG. 2 further illustrates an example haptic signal(s) 224 that may be output by the CPR feedback device 206 as feedback for the rescuer 204 to change the compression position. The haptic signal(s) 224 may be output via a haptic actuator(s) (e.g., a linear resonant actuator (LRA), an eccentric rotating mass (ERM), a piezoelectric actuator, etc.) of the CPR feedback device 206. In some examples, the defibrillator 208 and/or the rescuer device 212 is configured to cause the haptic signal(s) 224 to be output by the CPR feedback device 206, such as by transmitting an instruction(s) to output the haptic signal(s) 224. In some examples, the CPR feedback device 206 may include output devices (e.g., lights, speakers, etc.) to output the audible signal(s) 220 and/or the visual signal(s) 222 (described above) based on a similar instruction(s) received from the defibrillator 208 and/or the rescuer device 212. In an example, the output device(s) (of the CPR feedback device 206, the rescuer device 212, and/or the defibrillator 208) is an LED configured to emit light of various wavelengths or colors. In this example, to provide a visual feedback signal(s) 222 as feedback to change the compression position, the LED may emit red-colored light, which may be a visual signal for the rescuer 204 to change the compression position (e.g., to change their hand placement on the chest of the subject 104 until the LED emits a green-colored light indicative of correct compression position. In some examples, the rescuer device 212 is configured to output the haptic signal(s) 224, such as a rescuer device 212 that is worn by the rescuer 204 (e.g., a smart watch with a haptic actuator).

Upon receiving the feedback from the CPR feedback system 202, the rescuer 204 can utilize the feedback to adjust their technique for administering the chest compressions to the subject 104. For example, by observing/hearing/feeling the feedback signal(s) that is being output audibly, visually, and/or haptically by the CPR feedback system 202 of FIG. 2, the rescuer 204 can adjust their technique by, for example, changing their hand placement and administering chest compressions at a different compression position than before. In other words, the feedback provided to the rescuer 204 may be specifically designed for the rescuer 204 to dynamically adjust their hand placement during a CPR session in order to regain heart valve function during CPR (e.g., closure of the aortic valve and/or the pulmonary valve during the compression phase of the compression-decompression cycles), which is indicative of high quality CPR.

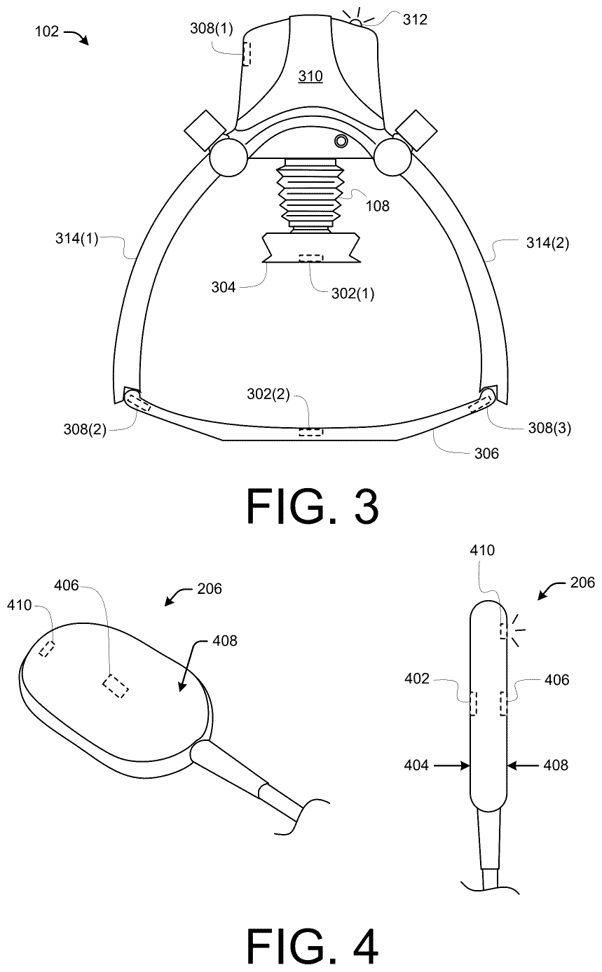

FIG. 3 illustrates the example mechanical chest compression device 102 depicted in FIG. 1, FIG. 3 depicting various example components of the mechanical chest compression device 102 to, among other things, record sounds (e.g., internal body sounds, environment sounds, etc.) and to output a feedback signal(s) relating to compression position. In the example of FIG. 3, the mechanical chest compression device 102 includes a first auscultation device 302(1) disposed on a distal end of the chest compressing mechanism 108, which is a piston in the example of FIG. 3. The distal end of the chest compressing mechanism 108 (e.g., piston) is configured to contact a chest of the subject 104 when the mechanical chest compression device 102 is secured around the subject 104 (e.g., around a thorax thereof). In an example, the distal end of the chest compressing mechanism 108 (e.g., piston) may include a suction cup 304 that is configured to adhere to the chest of the subject 104 in order to actively decompress the chest by pulling upward on the chest. In this example, the first auscultation device 302(1) is disposed on the suction cup 304. Because the first auscultation device 302(1) is disposed on the distal end of the chest compressing mechanism 108, the first auscultation device 302(1) is configured to be disposed on a thorax of the subject 104, and specifically on the chest of the subject 104. Accordingly, the first auscultation device 302(1) is configured to detect a heart sound associated with the subject 104. In the example of FIG. 3, the mechanical chest compression device 102 additionally, or alternatively, includes a second auscultation device 302(2) disposed on an inner surface of a backplate 306 of the mechanical chest compression device 102. FIG. 3 shows that the second auscultation device 302(2) as being positioned substantially in the center of the backplate 306, but the second auscultation device 302(2) can be positioned away from the center and closer to the sides of the backplate 306, so long as the second auscultation device 302(2) is positioned where it will contact the back of the subject 104 when the mechanical chest compression device 102 is secured around the subject 104. Because the backplate 306 is configured to be disposed under the back of the subject 104, and because the second auscultation device 302(2) is disposed on an inner surface of the backplate 306, the second auscultation device 302(2) is configured to be disposed on a thorax of the subject 104, and specifically on the back of the subject 104. Accordingly, the second auscultation device 302(2) is configured to detect a heart sound associated with the subject 104. In an example, the first auscultation device 302(1) is included in the mechanical chest compression device 102 and the second auscultation devices 302(2) is excluded or omitted from the mechanical chest compression device 102. In another example the second auscultation device 302(2) is included in the mechanical chest compression device 102 and the first auscultation device 302(1) is exclude or omitted from the mechanical chest compression device 102. In another example, both the first auscultation device 302(1) and the second auscultation device 302(2) are included in the mechanical chest compression device 102. In this example, two heart sound signals from two different sources are obtained and, if combined, a more reliable heart signal is obtained for the evaluation of the heart valve function. In an example, the auscultation device 302 (the first auscultation device 302(1) and/or the second auscultation device 302(2)) includes an array of auscultation devices 302 with multiple measurement sources spread out on a surface in contact to the subject 104 where several measurement signals are obtained, and if combined, the Signal-to-Noise (SNR) ratio may be improved.

The auscultation devices 302 can be implemented in various ways. In some examples, an auscultation device is, or includes, a microphone, a stethoscope (e.g., analog or digital), or any other suitable type of audio sensor. In some examples, an auscultation device is, or includes, a force sensor, a pressure sensor and/or the like. In some examples, the auscultation devices 302 include an analog to digital converter (ADC) and/or a transducer to convert detected heart sound signals into digital signals indicative of heart sound. In some examples, the auscultation devices 302 include components configured to magnify and/or amplify the detected sound, such as a bell and diaphragm in a stethoscope implementation. In some examples, upon detecting heart sound, the auscultation devices 302 can sample the heart sound to obtain a digital audio signal. In some examples, a microphone is used to sample the heart sound and to obtain a digital audio signal. Any suitable type of microphone can be used as part of the auscultation devices 302, such as dynamic microphones, condenser microphones, ribbon microphones, carbon microphones, crystal microphones, and/or the like.

In the example of FIG. 3, the mechanical chest compression device 102 additionally, or alternatively, includes a microphone 308(1) disposed on an external surface of the mechanical chest compression device 102. Although FIG. 3 shows the microphone 308(1) as being disposed on a main portion 310 of the mechanical chest compression device 102, the microphone 308(1) can be disposed elsewhere on any external surface of the mechanical chest compression device 102. The microphone 308(1) is configured to detect a sound in an environment (e.g., the environment 100) where the mechanical chest compression device 102 is located while chest compressions are being administered to the subject 104. By using the microphone 308(1) to detect environment sound, the processor(s) 106 of the mechanical chest compression device 102 may be configured to remove the sound in the environment detected by one or both of the auscultation devices 302(1), 302(2), such as by performing active-noise-cancellation (ANC) to remove the environment sound. For example, the processor(s) 106 may receive an audio signal(s) representing a heart sound detected by one or both of the auscultation devices 302(1), 302(2), and the processor(s) 106 may remove, from the audio signal, sound (e.g., environment sound) detected by the microphone 308(1). In some examples, the processor(s) 106 of the mechanical chest compression device 102 may be configured to perform signal averaging over multiple automated chest compressions administered to the subject 104. For example, the processor(s) 106 may be configured to average a gated portion of audio data generated using the auscultation device(s) 302 and/or the microphone(s) 308 over a predefined analysis window (e.g., a 10-second analysis window during an end of the compression phase and a start of the decompression phase of a compression-decompression cycle). This can improve the SNR of the audio data generated in association with the automated chest compressions In some examples, sounds within the chest of the subject 104, as recorded by the auscultation device(s) 302, can be used to adjust a CPR parameter(s) (e.g., compression position, compression depth, compression rate, etc.) and/or to cause a feedback signal(s) to be output to change the CPR parameter(s). In some examples, these “chest sounds” may exhibit the sound(s) of a heart valve(s) opening and/or closing, and/or other sounds associated with blood flow. For example, rules and/or statistical correlations can be generated based on an analysis of heart sounds during CPR to correlate particular chest sounds with “good” blood flow and other chest sounds with “poor” blood flow (e.g., a blood flow parameter that satisfies, or fails to satisfy, a threshold value).

Additionally, or alternatively, the microphone 308(1) can be used to record a monologue of a rescuer or a dialogue between multiple rescuers (or bystanders) at a rescue scene, which may be helpful for offline review of CPR quality, to record notes of a rescuer without the rescuer having to instruct an assistant to record hand-written notes in real-time, and/or the like. For example, rescuers may have conversations at a rescue scene while the mechanical chest compression device 102 is administering automated chest compressions, and a post review process may utilize recordings of these conversations to improve CPR training, to perform audits, and/or for legal reasons. In another example, a rescuer may speak into the microphone 308(1) to record notes in a hands-free manner (e.g., without having to use a separate recording device).

In the example of FIG. 3, the mechanical chest compression device 102 additionally, or alternatively, includes a light emitting element(s) 312, such as a LED(s), configured to emit light of various wavelengths or colors. Although FIG. 3 shows the light emitting element(s) 312 as being disposed on a main portion 310 of the mechanical chest compression device 102, the light emitting element(s) 312 can be disposed elsewhere on any external surface of the mechanical chest compression device 102. The light emitting element(s) 312 is configured to provide a visual feedback signal(s) as feedback relating to the compression position. For example, the light emitting element(s) 312 may emit red-colored light to indicate that the compression position should be changed, or a green-colored light to indicate that the compression position is correct. In some examples, the light emitting element(s) 312 may flash to indicate that the compression position is incorrect, and may emit a sustained light, or no light, to indicate that the compression position is correct. These are merely examples and the light emitting element(s) 312 may be configured to provide visual feedback relating to the compression position in other ways.

In the example of FIG. 3, the mechanical chest compression device 102 additionally, or alternatively, includes a second microphone 308(2) and/or a third microphone 308(3). The second microphone 308(2) is disposed in, or on, the backplate 306 near a first side of the backplate 306 that is configured to connect to a first leg 314(1) of a pair of legs 314 of the mechanical chest compression device 102. For example, the mechanical chest compression device 102 may include a pair of legs 314 extending from the main portion 310, each leg 314(1), 314(2) of the pair of legs 314 configured to connect to a respective side of the backplate 306. Accordingly, the second microphone 308(2), by being disposed near the first side of the backplate 306, is configured to detect an audible connection sound indicating that the first leg 314(1) has been connected to the backplate 306. Additionally, or alternatively, the third microphone 308(3) is disposed in, or on, the backplate 306 near a second side of the backplate 306 that is configured to connect to a second leg 314(2) of the pair of legs 314. Accordingly, the third microphone 308(3), by being disposed near the second side of the backplate 306, is configured to detect an audible connection sound indicating that the second leg 314(2) has been connected to the backplate 306. In some examples, one or both of the microphones 308(2), 308(3) can be used to detect an audible connection sound indicating that the pair of legs 314 have been connected to the backplate 306. In some examples, operation of the mechanical chest compression device 102 is disabled until the processor(s) 106 receives an indication that the microphone(s) 308(2) and/or 308(3) detected an audible connection sound, which may prevent operation of the mechanical chest compression device 102 while the legs 314 are not securely connected to the backplate 306. Accordingly, the processor(s) 106 may be configured to enable operation of the mechanical chest compression device 102 in response to receiving an indication that the audible connection sound(s) was detected by the microphone(s) 308(2) and/or 308(3), which ensures that the mechanical chest compression device 102 remains securely positioned on and/or around the subject 104 during a CPR session.

FIG. 4 illustrates the example CPR feedback device 206 depicted in FIG. 2, FIG. 4 depicting various example components of the CPR feedback device 206 to, among other things, record sounds (e.g., internal body sounds, environment sounds, etc.) and to output a feedback signal(s) relating to compression position. In the example of FIG. 4, the CPR feedback device 206 includes an auscultation device 402 disposed on an inner surface 404 of the CPR feedback device 206 that is configured to contact the chest of a subject 104 when the CPR feedback device 206 is placed on chest. Accordingly, the auscultation device 402 is configured to detect a heart sound associated with the subject 104 as manual chest compressions are being administered to the subject 104. The auscultation device 4002 may be implemented in the various ways described above with respect to the auscultation devices 302 of FIG. 3. In an example, the auscultation device 402 is not part of the enclosure (e.g., the inner surface 404) of the CPR feedback device 206, but rather includes an external part connected (via wire or wireless) to the CPR feedback device 206. In another example, the external part may include more than one auscultation device 402 integrated in one or more external parts. In another example, the external part may include a belt including one or more auscultation devices 402 configured to be wrapped around the chest of the subject 104.

In the example of FIG. 4, the CPR feedback device 206 additionally, or alternatively, includes a microphone 406 disposed on an outer surface 408 of the CPR feedback device 206. The microphone 406 is configured to detect a sound in an environment (e.g., the environment 200) where the CPR feedback device 206 is located while chest compressions are being administered to the subject 104 by the rescuer 204. By using the microphone 406 to detect environment sound, a processor(s) of the CPR feedback system 202 may be configured to remove the sound in the environment detected by the auscultation device 402, such as by performing ANC to remove the environment sound. For example, the processor(s) of the CPR feedback system 202 may receive an audio signal(s) representing a heart sound detected by the auscultation device 402, and the processor(s) may remove, from the audio signal, sound (e.g., environment sound) detected by the microphone 406. Additionally, or alternatively, the microphone 406 can be used to record a monologue of a rescuer 204 or a dialogue between multiple rescuers (or bystanders) at a rescue scene, which may be helpful for offline review of CPR quality, to record notes of a rescuer 204 without the rescuer having to instruct an assistant to record hand-written notes in real-time, and/or the like. For example, rescuers may have conversations at a rescue scene while the CPR feedback device 206 is being used in association with the administration of manual chest compressions, and a post review process may utilize recordings of these conversations to improve CPR training, to perform audits, and/or for legal reasons. In another example, a rescuer 204 may speak into the microphone 406 to record notes in a hands-free manner (e.g., without having to use a separate recording device). In an example, the microphone 406 is not part of the enclosure (e.g., the outer surface 408) of the CPR feedback device 206, but rather includes an external part connected (via wire or wireless) to the CPR feedback device 206.

In the example of FIG. 4, the CPR feedback device 206 additionally, or alternatively, includes a light emitting element(s) 410, such as a LED(s), configured to emit light of various wavelengths or colors. The light emitting element(s) 410 is configured to provide a visual feedback signal(s) as feedback relating to the compression position. For example, the light emitting element(s) 410 may emit red-colored light to indicate that the compression position should be changed, or a green-colored light to indicate that the compression position is correct. In some examples, the light emitting element(s) 410 may flash to indicate that the compression position is incorrect, and may emit a sustained light, or no light, to indicate that the compression position is correct. These are merely examples and the light emitting element(s) 410 may be configured to provide visual feedback relating to the compression position in other ways.

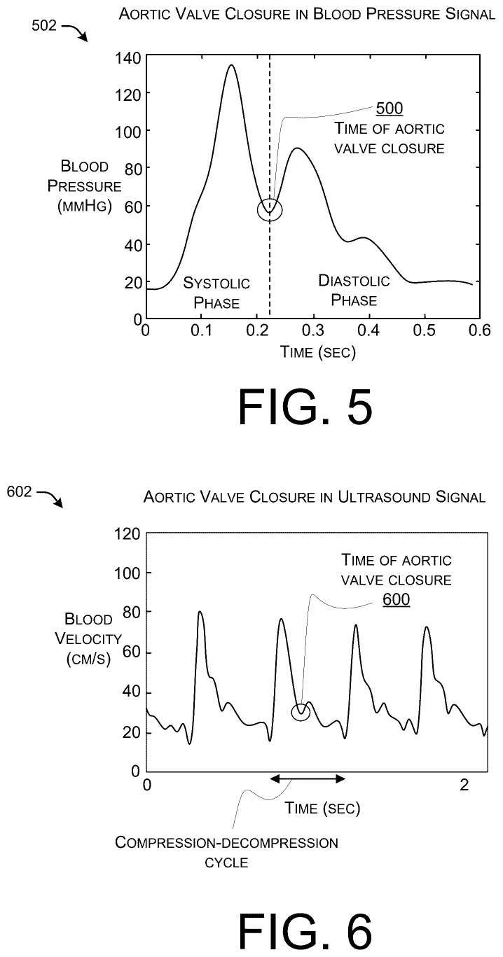

As noted above, a determination as to whether the heart valve of the subject 104 is functioning or not during CPR can be made based on the detection of aortic valve closure during a compression-decompression cycle. The aortic valve closure may be detected in several different physiological signals associated with the subject 104. FIGS. 5-8 illustrate various signals that can be analyzed for detecting closure of the aortic valve during CPR treatment of a subject 104. It is to be appreciated that detecting aortic valve closure in each of the signals depicted in FIGS. 5-8 is in relation to the compression-decompression cycle, where the compression-decompression cycle can be determined by (i) a timing signal generated by the mechanical chest compression device 102 that indicates when the compressions and/or decompressions occur (e.g., a timing signal with piston position information), (ii) a timing signal generated by the CPR feedback device 206 that indicates when the compressions and/or decompressions occur, and/or (iii) an algorithm that detects the timing of the compressions and/or the decompressions from a physiological signal (e.g., impedance, ECG, continuous blood pressure, blood flow, PPG, etc.).

FIG. 5 illustrates a time of aortic valve closure 500 exhibited in a blood pressure signal 502. For example, the pulse-shaped, continuous blood pressure signal 502 associated with a subject 104 can be analyzed (while the subject 104 is receiving CPR treatment) to identify the dicrotic notch in the blood pressure signal 502. In FIG. 5, the dicrotic notch, and thus the time point at which the aortic valve closes 500, is illustrated in the blood pressure signal 502, which may represent a continuous arterial blood pressure signal. A reliable arterial continuous blood pressure signal can be obtained from an invasive measurement, such as an arterial line. Accordingly, in some examples, a processor(s) of a CPR system and/or CPR device (e.g., the processor(s) of the mechanical chest compression device 102, the processor(s) of the defibrillator 208, the processor(s) of the rescuer device 212, etc.) is configured to determine, by analyzing a blood pressure parameter(s) sensed by a sensor(s), that an aortic valve of the heart of the subject 104 has closed, or that the aortic valve has closed incompletely. As used herein, a determination that a heart valve (e.g., the aortic valve) has “closed incompletely,” can mean that the heart valve has not closed at all, and/or that the heart valve has closed partially, but not completely. In the case of the aortic valve, incomplete closure during the compression phase of a compression-decompression cycle leads to backflow of blood into the heart via the aorta. This backflow of blood into the heart via the aorta will generate a characteristic heart sound in the form of a “blowing” sound, in the same way as a complete closure of the aortic valve will generate a distinct clear heart sound in the form of a “normal beating heart” sound.

FIG. 6 illustrates a time of aortic valve closure 600 exhibited in an ultrasound signal 602. The ultrasound signal 602 is another type of signal in which the dicrotic notch is visible and detectable. In FIG. 6, the dicrotic notch, and thus the time point at which the aortic valve closes 600, is illustrated in an ultrasound signal 602. The ultrasound signal is a non-invasive measurement, which is a particular advantage, as compared to, for example, a continuous arterial blood pressure signal or another invasive measurement. The pulse-shaped ultrasound signal 602 may be obtained in any blood vessel with a pulsatile flow. Thus, reliable detection of the time point for the closing of the aortic valve 600 may be obtained using an ultrasound signal 602. Accordingly, in some examples, a processor(s) of a CPR system and/or CPR device (e.g., the processor(s) of the mechanical chest compression device 102, the processor(s) of the defibrillator 208, the processor(s) of the rescuer device 212, etc.) is configured to determine, by analyzing an ultrasound parameter(s) (or a blood flow parameter(s)) sensed by a sensor(s), that that an aortic valve of the heart of the subject 104 has closed, or that the aortic valve has closed incompletely.

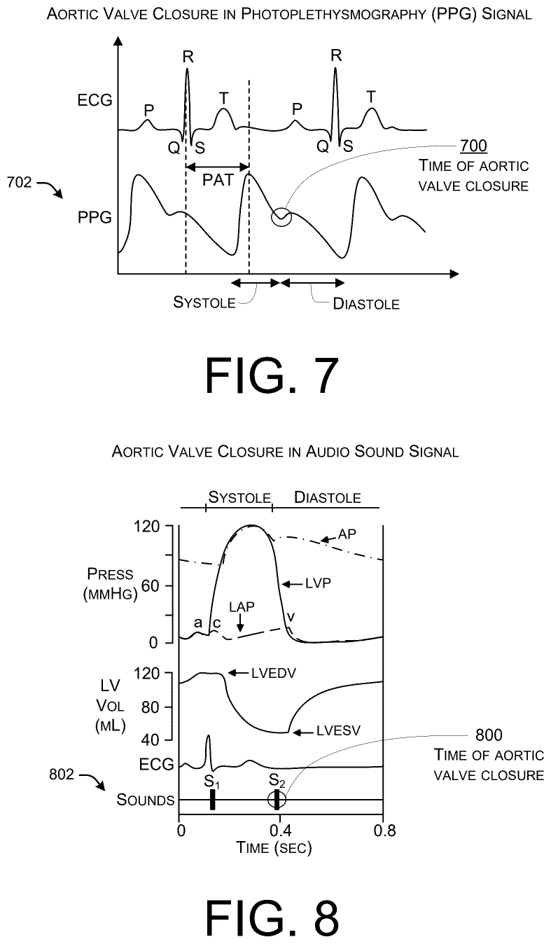

FIG. 7 illustrates a time of aortic valve closure 700 exhibited in a PPG signal 702. The PPG signal 702 is yet another physiological signal in which the dicrotic notch is visible and detectable. In FIG. 7, the dicrotic notch, and thus the time point at which the aortic valve closes 700, is illustrated in the PPG signal 702. The PPG signal 702 is also a non-invasive measurement, which is a particular advantage, as compared to, for example, a continuous arterial blood pressure signal or another invasive measurement. In some examples, the pulse-shaped PPG signal 702 may be obtained from a sensor(s) (e.g., a pulse oximeter) with access to any blood vessel with a pulsatile flow. Thus, a reliable detection of the time point for the closing of the aortic valve 700 may be obtained using a PPG signal 702. Accordingly, in some examples, a processor(s) of a CPR system and/or CPR device (e.g., the processor(s) of the mechanical chest compression device 102, the processor(s) of the defibrillator 208, the processor(s) of the rescuer device 212, etc.) is configured to determine, by analyzing a PPG parameter(s) sensed by a sensor(s), that an aortic valve of the heart of the subject 104 has closed, or that the aortic valve has closed incompletely.

FIG. 8 illustrates a time of aortic valve closure 800 exhibited in an audio sound signal 802. Heart sound is a physiological signal that does not rely on analyzing a pulse-shaped signal or detecting the presence of a dicrotic notch in a pulse-shaped signal to determine whether the aortic valve has closed. The beating sound from a spontaneously beating heart is generated by the closing of the heart valves. The heart sound during one cardiac cycle includes two beating sounds. The first, softer sound is generated by the closing of the mitral valve (and the closing of the tricuspid valve), and the second, louder sound is generated by the closing of the aortic valve (and the closing of the pulmonary valve). In FIG. 8, the two heart sounds, S₁ and S₂, during one cardiac cycle are illustrated in an audible sound signal 802, where the second beating sound, S₂, defines the time point for the closing of the aortic valve 800. In the case of an incomplete closing of the aortic valve, a second beating sound, S2, may still be generated even though as less distinct and with a lower magnitude and/or volume. Moreover, an additional sound characterized as a “blowing” sound (i.e., a noisier sound and less clear and sharp than the sound of the aortic valve closing completely) will also be generated directly following the time instance of the second beating sound, S2. In an example, this “blowing” sound may be used to determine an incomplete closing of the aortic valve. In another example, the lack of the second beating sound, S2, may be used to determine an incomplete closing of the aortic valve. In another example, the combination of a “blowing” sound and a lack of the second beating sound, S2, may be used to determine an incomplete closing of the aortic valve. Similarly, in the case of an incomplete closing of the mitral valve, a first beating sound, S1, may still be generated even though as less distinct and with a lower magnitude and/or volume. Moreover, an additional sound characterized as a “blowing” sound (i.e., a noisier sound and less clear and sharp than the sound of the mitral valve closing completely) will also be generated directly following the time instance of the first beating sound, S1. In an example, this first “blowing” sound may be used to determine an incomplete closing of the mitral valve. The heart sound signal 802 is also a non-invasive measurement, which is a particular advantage, as compared to, for example, a continuous arterial blood pressure signal. An audible heart sound signal may be obtained from an auscultation device(s)/sensor(s) (e.g., auscultation device(s) 302, auscultation device 402, etc.), such as a microphone(s), attached to, and/or placed on, the skin surface of the thorax (e.g., the chest or the back) of the subject 104. During CPR, closure of the heart valves (if they close at all) may occur differently compared to closure of the heart valves during a normal beating heart (i.e., in a non-cardiac arrest patient), which especially applies to the closure of the aortic valve. During CPR, it is not uncommon that the aortic valve closes twice directly after each other, i.e., directly after the normal closing of the aortic valve, the aortic valve may open slightly again, which is directly followed by a second closing of the aortic valve. A CPR treatment may be seen as an unphysiological contraction of the heart (which may create different pressures, pressure gradients, venous return, cardiac filling, atrial volumes, ventricle volumes, blood flows, and cardiac output, compared to a normal beating heart) that may result in a “double” closing of the aortic valve. A double closing of the aortic valve may also occur in a normal beating heart. However, this condition is uncommon in non-cardiac arrest subjects and is thus rarely seen. The second aortic valve closure will also generate a heart sound, so, instead of having one heart sound associated with a time of aortic valve closure (e.g., the time of aortic valve closure 800 associated with the second sound, S2, in FIG. 8), there can be two heart sounds corresponding to closure of the aortic valve, one sound directly following the other sound (e.g., this would be shown as two second sounds, S2(1) and S2(2), in FIG. 8 instead of the single second sound shown in FIG. 8). The sound level (i.e., magnitude and/or volume) of the first second heart sound S2 (e.g., S2(1)) will be higher (e.g., greater) than the sound level of the following second heart sound S2 (e.g., S2(2)). Similarly, the second aortic valve closure will also generate a dicrotic notch, so instead of having one dicrotic notch associated with a time of aortic valve closure (e.g., 500, 600, and 700 in association with FIGS. 5, 6, and 7), there will be two dicrotic notches directly following each other (e.g., this would be shown as two dicrotic notches in FIGS. 5, 6, and 7 instead of the single dicrotic notch in each of those figures). A double sequential closing of the aortic valve is in fact a closing of the aortic valve and may thus be viewed as high quality CPR and/or correct compression position. In other words, the analysis of the heart valve function, and the determination that the heart valve of the subject 104 is functioning, may, e.g., involve determining that the aortic valve or the pulmonary valve closed completely and/or may involve determining that the aortic valve or the pulmonary valve closed twice during one compression-decompression cycle. During CPR, the aortic valve may close three times directly after each other, e.g., directly after the first closing of the aortic valve, the aortic valve may open slightly again, which is directly followed by a second closing of the aortic valve, and then the aortic valve may open slightly again a second time, which is directly followed by a third closing of the aortic valve. The third aortic valve closure will also generate a heart sound, so instead of having one or two sound(s) associated with a time(s) of aortic valve closure (as described above), there may be three sounds, the latter two sounds directly following a preceding sound. Similarly, the third aortic valve closure will also generate a dicrotic notch, so instead of having one or two dicrotic notch(es) associated with a time of aortic valve closure (as described above), there may be three dicrotic notches, the latter two dicrotic notches directly following a preceding dicrotic notch (e.g., this would be shown as three dicrotic notches in FIGS. 5, 6, and 7 instead of the single dicrotic notch in each of those figures). A triple sequential closing of the aortic valve is in fact a closing of the aortic valve and may thus be viewed as high quality CPR and/or correct compression position. In an example, the number of sequential aortic valve closures e.g. the number of zero, one, two, or three (i.e. the number of sequential “second” heart sounds S2 in FIG. 8, or similarly, the number of dicrotic notches in FIGS. 5, 6, or 7) may not only be used to determine the CPR quality and/or the compression position, but may also be used to further diagnose the subject 104, e.g. with respect to pressures, pressure gradients, venous return, cardiac filling, atrial volumes, ventricle volumes, blood flows, and cardiac output (as describe above), or to determine the dominate pump mechanism (i.e. the cardiac pump mechanism or the thoracic pump mechanism) that is active in the subject 104 and is the underlying cause of blood circulation. During CPR, closure of the heart valves (if they close at all) may occur sequentially or simultaneously (or near simultaneously). The timing of the heart valves closing is a function of chamber filling volume and the pressure in the chamber and/or vessel in which the blood is ejected during the compression. For example, when there is right-ventricular distension, the pulmonary valve closing may create the first heart sound (of multiple heart sounds) exhibited in an audible heart sound signal. Therefore, during CPR, heart sounds may occur in a relatively normal sequence, in an abnormal sequence, or simultaneously. Moreover, the timing and/or the sequence of the heart sounds can provide insight into what the limiting factor might be to maximize blood flow in the body of the subject. Accordingly, in some examples, when the compression position is correct during the administration of CPR, two heart sounds may be exhibited in an audible heart sound signal during one compression-decompression cycle, and the latter of the two heart sounds may correspond to closure of the aortic valve. Thus, a reliable detection of the time point for the closing of the aortic valve 800 may be obtained using an audible sound signal 802 captured using an auscultation device(s)/sensor(s) (e.g., a microphone(s)) during CPR. Accordingly, in some examples, a processor(s) of a CPR system and/or CPR device (e.g., the processor(s) of the mechanical chest compression device 102, the processor(s) of the defibrillator 208, the processor(s) of the rescuer device 212, etc.) is configured to determine, by analyzing an audible heart sound parameter(s) sensed by a sensor(s), that an aortic valve of the heart of the subject 104 has closed, or that the aortic valve has closed incompletely. For instance, during a latter portion of the compression phase during a compression-decompression cycle (e.g., shortly after a time at which a target compression depth is reached and the chest of the subject 104 is held in the compressed state for a brief period of time), the aortic valve of the heart may close during this period in scenarios where the compression position is correct. In some examples, any heart sound corresponding to heart valve closure during a compression-decompression cycle may be indicative of a correct compression position. In some examples, a correlation between heart sounds and corresponding physiology may be determined and used to determine whether a heart valve is functioning or not and/or whether a compression parameter(s) (e.g., compression position, compression rate, compression depth, etc.) should be adjusted and, if so, how to adjust the compression parameter(s). In some examples, the processor(s) is configured to determine a return and/or an occurrence of “normal” S1 and S2 sounds exhibited in an audible sound signal 802 (e.g., during CPR pauses), and based on this determination, the processor may detect return of spontaneous circulation (ROSC).

As mentioned, the dicrotic notch in a pulse-shaped signal may be used to detect the time point of the closing of the aortic valve. However, in some instances, the dicrotic notch may not be visible in the signal, making it difficult to detect closure of the aortic valve via such a signal, at least in some patient populations (e.g., in patients with arterial stiffness). The pulse shape tends to be more triangular shaped the more arterial stiffness progresses, and in patients with severe arterial stiffness, the dicrotic notch is completely lacking. Thus, in some patient populations it is beneficial to detect the closing of the aortic valve using a physiological signal that does not rely on a detectable dicrotic notch, such as the audible sound signal 802 described above. There are other patient populations that may cause interference with the measurement of physiological signals, such as diabetes patients. Smaller blood vessels tend to be occluded in diabetes patients, which may result in poor perfusion. The poor perfusion in diabetes patients may influence the measurement of a PPG signal, and, in some cases, it may even make the detection of aortic valve closure impracticable.

In an example, the analysis of the heart valve function (e.g., detecting closure or incomplete closure of the aortic valve) is performed for every single compression-decompression cycle (e.g., for every generated heart sound and/or for every dicrotic notch in a pulse shaped signal) over time. This will give an instantaneous feedback of CPR quality and/or compression position for every single chest compression of the subject 104. However, in some situations, the analysis of the heart valve function may be challenging, and the determination may switch back and forth between a detected closure and a detected incomplete closure, even though the CPR quality and/or the compression position is unchanged. This will result in an unreliable determination of the CPR quality and/or compression position. A way to mitigate this, is to introduce a third determination alternative as “inconclusive detection” in these situations when the analysis of the heart valve function may be challenging. The “inconclusive” state may be communicated to the user by emitting light of a particular color (e.g., yellow-colored light instead off green light or red light). In another example, the analysis of the heart valve function (e.g., detecting closure or incomplete closure of the aortic valve) is performed by using several consecutive previous compression-decompression cycles (e.g., for several previously generated heart sounds and/or dicrotic notches in a pulse shaped signal) over time, which is a different approach than analyzing heart valve function during every single current compression-decompression cycle. This will result in a more robust and reliable determination of CPR quality and/or compression position. The drawback of this implementation is that the user (e.g., a rescuer) will not get instantaneous feedback, but rather a time delayed response in case of a change in CPR quality and/or compression position. As long as the CPR quality and/or the compression position is unchanged by the user, this time delay will be of less concern and importance for the user. It should be noted that, the more previous compression-decompression cycles used, the more robust and reliable determination of CPR quality and/or compression position is obtained and the longer time delay in the response of a CPR quality and/or compression position change. The optimal number of previous compression-decompression cycles used in the analysis of the heart valve function differs from situation to situation and is dependent on the prioritization between the determination reliability and the response time delay. In another example, more sensors (e.g., microphones) may be used in the analysis of the heart valve function, which will result in a more reliable determination without causing a response time delay, or with a reduced response time delay. It is to be appreciated that, in addition to using these techniques or the techniques described further above for detecting closure of the aortic valve, other techniques can be used in combination with one or more of those techniques for purposes of detecting aortic valve closure. For example, detecting closure of the aortic valve may include the use of one or more detection and classification techniques, such as the use of adaptive filters, matched filters, time and frequency domain methods, correlation and cross-correlation methods, and/or artificial intelligence methods (e.g., machine learning models, including neural networks and the like).

It is also to be appreciated that the time point for the closing of the pulmonary valve is associated with the time point for the closing of the aortic valve. Therefore, wherever closure of the “aortic valve” is discussed herein, the same holds true for the closing of the pulmonary valve, and vice versa. In other words, the determination to adjust the compression position may be based at least in part on determining that the pulmonary valve of the heart of the subject 104 closed incompletely, as the closure of the aortic valve and the pulmonary valve occurs at similar times during CPR. Thus, all instances of “aortic valve” herein may be used interchangeably with “pulmonary valve.”

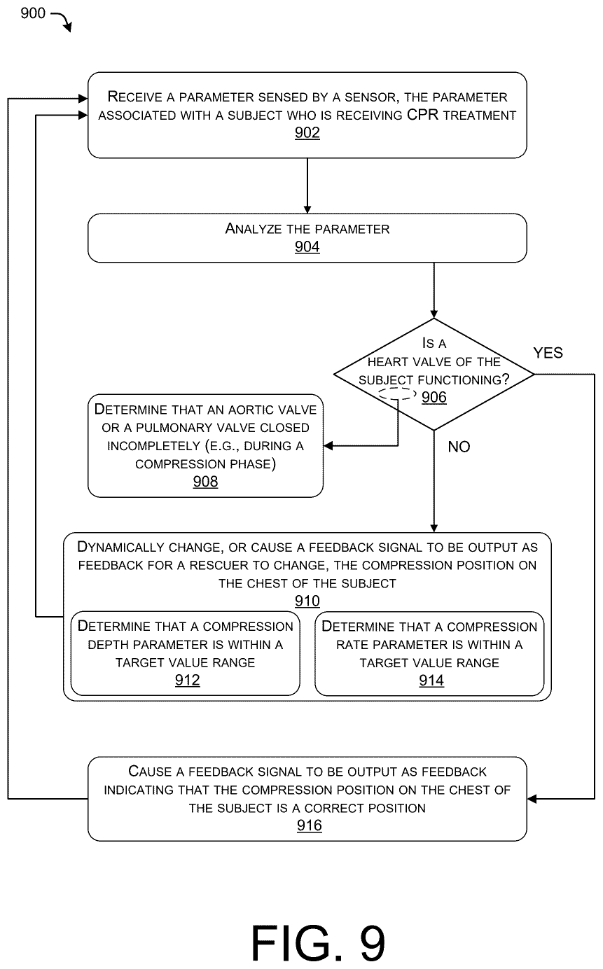

FIGS. 9, 11, and 12 illustrate processes and/or techniques performed by one or more systems, devices, or entities described herein. For example, the processes/techniques illustrated in FIGS. 9, 11, and 12 may be implemented by a CPR system and/or device, whether the device is a standalone device or part of a CPR system, and/or by at least one processor configured to execute instructions. The processes described herein represent sequences of operations that can be implemented in hardware, software, or a combination thereof. In the context of software, the blocks represent computer-executable instructions stored on one or more computer-readable storage media that, when executed by a processor(s), perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes. In some examples, an operation(s) of the process may be omitted entirely. Moreover, the processes described herein can be combined in whole or in part with each other or with other processes.

FIG. 9 illustrates an example process 900 for analyzing a parameter(s) indicative of heart valve function of a subject as the subject is receiving CPR treatment, and dynamically changing, and/or causing output of a feedback signal relating to, a compression position based at least in part on the parameter analysis. The process 900 is performed by an entity including, for example, one or more devices of a CPR system, such as the mechanical chest compression device 102 of FIG. 1, the mechanical chest compression device 1600 of FIG. 16, one or more devices of the CPR feedback system 202 of FIG. 2, such as the defibrillator 208 of FIG. 2, the defibrillator 1500 of FIG. 15, the rescuer device 212 of FIG. 2, the CPR feedback device 206 of FIG. 2, a processor(s) of any of the aforementioned devices and/or a processor(s) of any other device(s) that is part of a CPR system.

At 902, the entity receives a parameter(s) associated with a subject 104 and sensed by sensor(s) of a CPR system during administration of chest compressions to the subject 104. The parameter(s) received at 902 can vary, as described above, and may include one or more of a blood pressure parameter(s) (See FIG. 5), a blood flow parameter(s) and/or an ultrasound parameter(s) (See FIG. 6), a PPG parameter(s) (See FIG. 7), and/or an audible heart sound parameter(s) (See FIG. 8). In some examples, the parameter(s) received at 902 is a heart valve parameter(s), and the sensor(s) is a measuring device(s) configured to be disposed on the subject 104 and to detect the heart valve parameter(s) as chest compressions are being administered to the subject 104. In some examples, the measuring device(s) is configured to obtain a pulse wave signal(s) from a blood pressure recording (See FIG. 5), an ultrasound recording (See FIG. 6), and/or a PPG recording (See FIG. 7). In some examples, the heart valve parameter(s) is a dicrotic notch(es) in a pulse wave signal(s). In some examples, the heart valve parameter(s) is an audio signal(s). In some examples, the sensor(s) (e.g., a measuring device(s)) is an auscultation device(s)/sensor(s) (e.g., a microphone(s)) configured to be disposed on a thorax of the subject 104, and the parameter(s) sensed by the sensor(s) is an audible heart sound parameter (See FIG. 8). For example, the sensor(s) may be one or both of the auscultation devices 302(1) and/or 302(2) of the mechanical chest compression device 102. As another example, the sensor(s) may be the auscultation device 402 of the CPR feedback device 206. In some examples, the auscultation device(s)/sensor(s) includes an array of microphones configured to be disposed on the thorax of the subject 104 and to detect an audible heart sound(s) associated with the subject 104. In some examples, the auscultation device(s)/sensor(s) includes multiple microphones configured to be disposed at different locations on the thorax of the subject 104 and to detect an audible heart sound(s) associated with the subject 104. An array of microphones and/or multiple microphones may be used to improve a signal-to-noise ratio (SNR) of the resulting audio signal.

At 904, the entity analyzes the parameter(s) received at 902. In some examples, the analyzing at 904 includes analyzing a pulse-shaped signal(s) (or pulse wave signal(s)) associated with a subject 104 to identify a dicrotic notch in the pulse-shaped signal(s). In some examples, the analyzing at 904 includes determining a time, during a compression-decompression cycle, of the occurrence of the dicrotic notch. In some examples, the analyzing at 904 includes analyzing a heart valve parameter(s) to identify a feature(s) indicative of an aortic valve or a pulmonary valve of the heart of the subject 104 closing completely. In some examples, the analyzing at 904 includes analyzing an audio signal, such as an audible heart sound signal representing a heart sound detected by the auscultation device(s)/sensor(s), to identify a latter of two beating sounds (See e.g., beating sound, S₂, in FIG. 8).

At 906, the entity determines, by analyzing the parameter(s) at 904, whether a heart valve of the subject 104 is functioning or not. As shown by sub-block 908, in some examples, determining whether the heart valve of the subject 104 is functioning or not includes determining whether an aortic valve or a pulmonary valve of the heart closed completely during a compression-decompression cycle. In some examples, the entity, at 908, determines whether the aortic valve or the pulmonary valve closed completely during a compression phase of the compression-decompression cycle. In the case of the aortic valve, incomplete closure during the compression phase (e.g., at the end of the compression phase) of a compression-decompression cycle leads to backflow of blood into the heart via the aorta, and, hence, the incomplete closure of the aortic valve during the compression phase is indicative of the heart valve not functioning (e.g., due to an incorrect compression position). In some examples, the entity, at 908, determines whether the aortic valve or the pulmonary valve closed completely during a decompression phase of the compression-decompression cycle. For example, if a given chest compression does not last long enough for the aortic valve to close, the decompression phase may force closure of the aortic valve by rapidly expanding the left ventricle of the heart. As another example, one or more heart valves (e.g., the aortic valve) may close during the decompression phase in other scenarios, such as scenarios where the compression phase is relatively long. In such scenarios, incomplete valve closure during the decompression phase may be indicative of the heart valve not functioning (e.g., due to an incorrect compression position). If, for instance, a chest compression deforms the valve (e.g., aortic valve) by pressing on the left ventricle outflow tract, this may prevent the aortic valve from closing completely, and, in this scenario, decompressing the chest may remove the force that is deforming the left ventricle outflow tract, allowing normal heart valve function to resume after the compression phase and during the decompression phase. If the entity determines, at 906, that the heart valve of the subject 104 is not functioning (e.g., by determining that the aortic valve or the pulmonary valve of the heart closed incompletely during a compression-decompression cycle (e.g., during a compression phase or a decompression phase thereof), by determining that a heart valve parameter lacks a feature indicative of the aortic valve or the pulmonary valve closing completely during a compression-decompression cycle (e.g., during a compression phase or a decompression phase thereof), etc.), the process 900 follows the NO route from 906 to 910.

At 910, the entity dynamically changes, and/or causes a feedback signal(s) to be output as feedback for a rescuer to change, a compression position on the chest of the subject 104 during the CPR treatment. For example, in an implementation where the CPR system is, or includes, a mechanical chest compression device 102, in response to determining, at 906, that the heart valve of the subject 104 is not functioning (e.g., by determining, at 908, that the aortic valve or the pulmonary valve closed incompletely), the entity may cause a chest compressing mechanism 108 (e.g., piston) to change a position on the chest of the subject 104 at which future chest compressions are to be administered to the subject 104. As another example, in an implementation using any CPR system described herein, in response to determining, at 906, that the heart valve of the subject 104 is not functioning (e.g., by determining, at 908, that the aortic valve or the pulmonary valve closed incompletely), the entity may cause a feedback signal(s) to be output as feedback to change a position on a chest of the subject 104 at which future chest compressions are to be administered to the subject 104. In an implementation where the CPR system is, or includes, a mechanical chest compression device 102, the feedback may instruct a rescuer to change the position on the chest of the subject 104 at which of the chest compressing mechanism 108 (e.g., piston) is disposed, such as by the light emitting element(s) 312 (e.g., LED) disposed on an external surface of (e.g., the main portion 310 of) the mechanical chest compression device 102 emitting light of a particular color (e.g., red-colored light) and/or flashing light to indicate that the compression position should be changed. In an implementation where the CPR system is a CPR feedback system 202, the feedback may instruct a rescuer 204 to change the position on the chest of the subject 104 at which their hands are placed for manually administering the chest compressions, such as by the light emitting element(s) 410 (e.g., LED) disposed on an outer surface 408 of the CPR feedback device 206 emitting light of a particular color (e.g., red-colored light) and/or flashing light to indicate that the compression position should be changed.

As shown by sub-blocks 912 and 914, the operation(s) performed at 910 may be based at least in part on one or more additional determinations. At 912, for example, the entity determines that a compression depth parameter(s) associated with the chest compressions is within a first target value range (e.g., a range of 5 centimeters (cm) to 6 cm, a range of 5 cm to 5.5 cm, a range of 5.5 cm to 6 cm, etc.). At 914, as another example, the entity determines that a compression rate parameter(s) associated with the chest compressions is within a second target value range (e.g., a range of 100 compressions per minute to 120 compressions per minute, a range of 100 compressions per minute to 110 compressions per minute, a range of 110 compressions per minute to 120 compression per minute, etc.). In these examples, the operation(s) performed at 910 may be performed in response to determining that the compression depth parameter(s) is within the first target value range and/or that the compression rate parameter(s) is within the second target value range. In this way, the entity can rule out that compression depth or compression rate is the cause of low quality CPR before determining that the compression position should be changed to improve CPR quality.

If the entity determines, at 906, that the heart valve of the subject 104 is functioning (e.g., by determining that the aortic valve or the pulmonary valve of the heart closed completely during a compression-decompression cycle (e.g., during a compression phase or a decompression phase thereof), by determining that a heart valve parameter includes a feature indicative of the aortic valve or the pulmonary valve closing completely during a compression-decompression cycle (e.g., during a compression phase or a decompression phase thereof), etc.), the process 900 follows the YES route from 906 to 916. In some examples, the entity analyzes the parameter(s) at a first time at 904 to determine that the heart valve of the subject is not functioning at 906 during a first iteration of the process 900, and after the compression position is adjusted, during a second iteration of the process 900, the entity analyzes the parameter(s) at a second time at 904, the second time after the first time, to determine that the heart valve of the subject is functioning at 906 (which may be due to the previous compression position adjustment).

At 916, in response to determining, at 906, that the heart valve of the subject 104 is functioning (e.g., by determining, at 908, that the aortic valve or the pulmonary valve closed completely), the entity may cause a feedback signal(s) to be output as feedback indicating that the position on the chest at which the chest compressions are being administered to the subject 104 is a correct position. In some examples, the feedback may indicate, to a rescuer, that the compression position is correct, such as by the light emitting element(s) 312, 410 (e.g., LED(s)) emitting light of a particular color (e.g., green-colored light) and/or sustained light to indicate that the compression position is correct. In some examples, in response to determining, at 906, that the heart valve of the subject 104 is functioning, no feedback signal(s) is output, and the process 900 returns to 902, where no feedback provided is interpreted, by a rescuer, as a correct compression position. Additionally, or alternatively, following either of blocks 910 or 916, the process 900 returns to 902, as shown by the return arrows leading back to 902, where the process 900 iterates as CPR treatment continues. Accordingly, the process 900 may iterate throughout a CPR session to continually evaluate compression position and/or CPR quality and adjust the compression position, as needed, to improve CPR quality dynamically as the subject receives the CPR treatment.

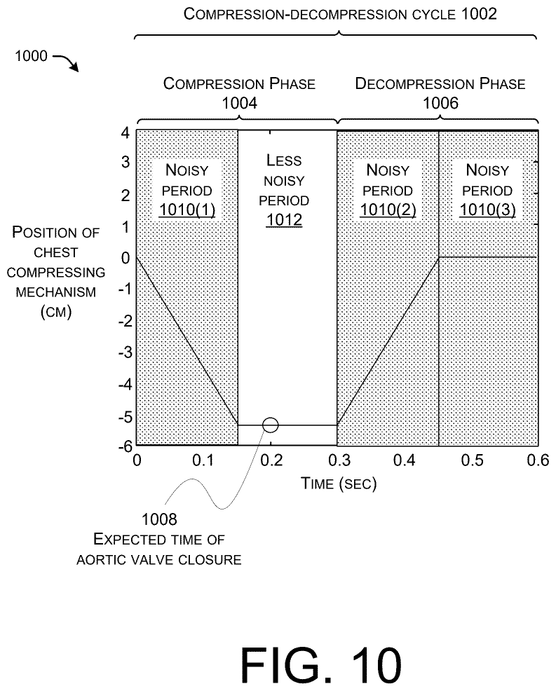

FIG. 10 illustrates a compression and decompression profile (or, “waveform” 1000) that includes period of time with reduced noise during which a heart sound can be detected, as described herein. As shown in the waveform 1000, a compression-decompression cycle 1002 includes a compression phase 1004 followed by a decompression phase 1006. Although a 50:50 duty cycle is shown in FIG. 10 with the compression phase 1004 and the decompression phase 1006 being equal in duration, it is to be appreciated that other duty cycles can be implemented with the techniques, devices, and systems described herein, such as a duty cycle where the compression phase 1004 is shorter than the decompression phase 1006 (e.g., a 40:60 duty cycle). With the 50:50 duty cycle depicted in the waveform 1000, the first 0.3 seconds of the compression-decompression cycle 1002 represents the compression phase 1004 and the last 0.3 seconds of the compression-decompression cycle 1002 represents the decompression phase 1006, e.g., the total time of the compression-decompression cycle 1002 is 0.6 seconds which corresponds to a compression rate of 100 compressions per minute. Although a rate of 100 compressions per minute is shown in FIG. 10, it is to be appreciated that other compression rates can be implemented with the techniques, devices, and systems described herein, such as a compression rate of 110 or 120.

The waveform 1000 indicates that the chest compressing mechanism 108 of the mechanical chest compression device 102 starts at a first position of 0 centimeters (cm), and begins moving (e.g., downward, towards the subject 104) at a constant velocity until the chest compressing mechanism 108 arrives at a second position of about negative 5.3 cm. This second position (negative 5.3 cm) of the chest compressing mechanism 108 may represent a target compression depth, and the chest compressing mechanism 108 arrives at the target compression depth at about 0.15 seconds into the compression-decompression cycle 1002. After arriving at the second position (negative 5.3 cm), the chest compressing mechanism 108 refrains from moving during a first hold period that spans from about 0.15 seconds to 0.3 seconds into the compression-decompression cycle 1002. For different duty cycles and/or compression rates, this first hold period can be shorter. During this first hold period, in this example, the aortic valve of the heart of the subject 104 is expected to close at around 0.2 seconds into the compression-decompression cycle 1002. This is shown in the waveform 1000 of FIG. 10 as the expected time of aortic valve closure 1008. In the example of FIG. 10, at 0.3 seconds into the compression-decompression cycle 1002, the chest compressing mechanism 108, which is at the second position (negative 5.3 cm), begins moving (e.g., upward, away from the subject 104) at a constant velocity until the chest compressing mechanism 108 returns to the first position of 0 cm at about 0.45 seconds into the compression-decompression cycle 1002. After returning to the first position (0 cm), the chest compressing mechanism 108 refrains from moving during a second hold period that spans from about 0.45 seconds to 0.6 seconds, which marks the end of the compression-decompression cycle 1002. Again, for different duty cycles and/or compression rates, this second hold period can be longer and/or shorter. Additionally, or alternatively, the mechanical chest compression device 102 may be configured to implement active decompression during the decompression phase 1006, whereby the chest compressing mechanism 108 continues moving past the first position (0 cm) at 0.45 seconds into the compression-decompression cycle 1002 and stops moving at a third position greater than 0 cm to initiate the second hold period at a position where the chest is being held in a decompressed state by actively applying an upward force to the chest (e.g., by pulling on the chest using the suction cup 304 of the mechanical chest compression device 102). Although the waveform 1000 depicted in FIG. 10 is trapezoidal in shape, this is non-limiting, as the waveform 1000 can be of any suitable shape, such as a sinusoidal waveform, a triangular-shaped (e.g., sawtooth) waveform, a rectangular-shaped waveform, a square-shaped waveform, or a waveform having any suitable polygonal shape.

As shown in FIG. 10, there may be more or less noise in the environment of the subject 104 (e.g., the environment 100) during particular periods of time throughout a compression-decompression cycle 1002. For example, there may be a first noisy period 1010(1) at a beginning of the compression phase 1004 due to noise generated by the mechanical chest compression device 102 as the chest compressing mechanism 108 moves (e.g., downward, towards the subject 104) from the first position to the second position (e.g., the target compression depth). The noise during this first noisy period 1010(1) may be generated by the chest compressing mechanism 108 (e.g., due to movement thereof), by the motor that drives the chest compressing mechanism 108, and/or the like. There may be a less noisy period 1012 (e.g., a noise-free period) at an end of the compression phase 1004 during the first hold period because the chest compressing mechanism 108 does not move during the first hold period. This less noisy period is an optimal time period during the compression-decompression cycle 1002 for detecting a heart sound associated with the subject 104 (e.g., using an auscultation device(s)/sensor(s)) due to the reduced noise during the less noisy period 1012. There may be a second noisy period 1010(2) at a beginning of the decompression phase 1006 due to noise generated by the mechanical chest compression device 102 as the chest compressing mechanism 108 moves (e.g., upward, away from the subject 104) from the second position back to the first position. The noise during this second noisy period 1010(2) may be generated by the chest compressing mechanism 108 (e.g., due to movement thereof), by the motor that drives the chest compressing mechanism 108, and/or the like. There may be a third noisy period 1010(3) at an end of the decompression phase 1006 due to noise generated as ventilation is administered to the subject 104. The noise during this third noisy period 1010(3) may be generated by a ventilator, such as a bag-valve-mask device administering a breath to the subject 104.

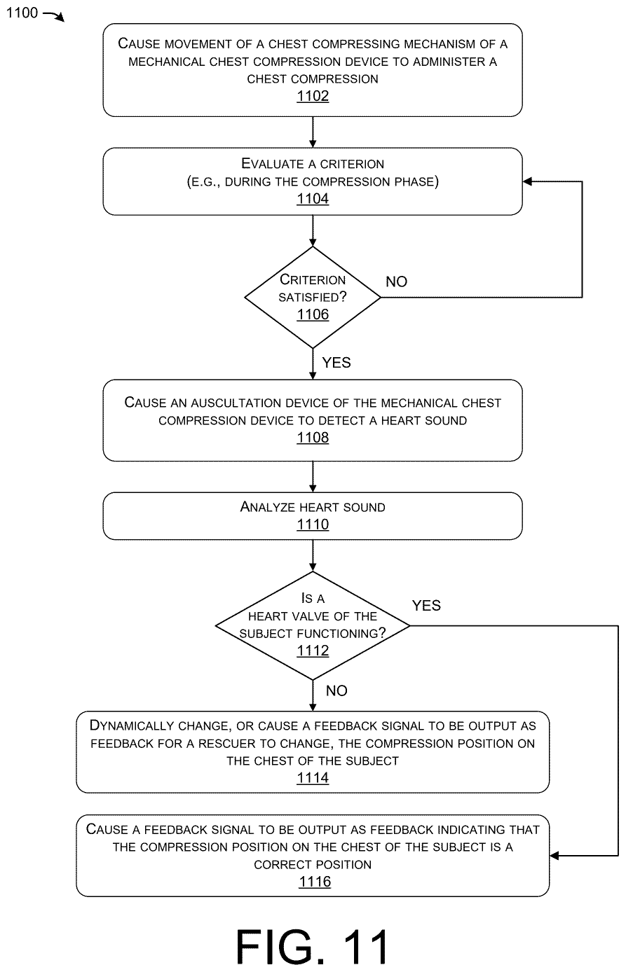

FIG. 11 illustrates an example process 1100 for detecting a heart sound at a particular time during a compression-decompression cycle to mitigate noise during the detection of the heart sound, analyzing the detected heart sound to determine whether a heart valve of a subject is functioning, and dynamically changing, and/or causing output of a feedback signal relating to, a compression position based at least in part on the heart sound analysis. The process 1100 is performed by an entity including, for example, one or more devices of a CPR system, such as the mechanical chest compression device 102 of FIG. 1, the mechanical chest compression device 1600 of FIG. 16, a processor(s) of any of the aforementioned devices and/or a processor(s) of any other device(s) that is part of a CPR system.

At 1102, the entity causes movement of a chest compressing mechanism 108 of a mechanical chest compression device 102 to administer a chest compression to a subject 104. In some examples, the movement of the chest compressing mechanism 108 is during a compression phase 1004 of a compression-decompression cycle 1002. Accordingly, the movement of the chest compressing mechanism 108 at 1102 may be downward movement (e.g., the piston extending and applying a downward force to the chest of the subject 104) during one compression-decompression cycle 1002 of a series of compression-decompression cycles over which the chest compressing mechanism 108 moves for administering chest compressions to the subject 104. However, the type of movement of the chest compressing mechanism 108 may depend on the type of mechanical chest compression device that is utilized for administering CPR treatment to the subject 104. For example, a piston-based mechanical chest compression device 102, as shown in FIG. 1, includes a chest compressing mechanism 108 in the form of a piston, and the piston is configured to be placed on the chest of the subject 104 and to repeatedly extend and/or move downward, toward the subject 104, to apply a downward force to the chest for administering chest compressions to the subject 104 and to release the applied force by retracting and/or moving upward, away from the subject 104, in between successive applications of the downward force. As another example, a vest-based mechanical chest compression device includes a chest compressing mechanism in the form of a load-distributing band, and the load-distributing band is configured to be placed on the chest of the subject 104 and to repeatedly apply a distributed (squeezing) force that is directed inward towards the chest for administering chest compressions to the subject 104 and to release the applied force in between successive applications of the force.

At 1104, the entity evaluates a criterion (or criteria) to determine whether the criterion (or criteria) is satisfied at 1106. In some examples, the criterion is evaluated at 1104 during the compression phase 1004. In some examples, determining whether the criterion is satisfied at 1106 includes determining, during the compression phase 1004, that the chest compressing mechanism 108 has reached a target compression depth. For example, the chest compressing mechanism 108 may be configured to move along an axis of extension/retraction, during a compression phase 1004 of a compression-decompression cycle 1002, from a first position (e.g., 0 cm) to a second position (e.g., negative 5.3 cm) that represents a target compression depth, and the criterion may be satisfied at 1106 when the entity determines that the chest compressing mechanism 108 has arrived at the second position (e.g., the target compression depth). In some examples, the criterion may be satisfied at 1106 when the entity determines an expiration of a predetermined amount of time (e.g., 0.15 seconds) since a start of the compression phase 1004. That is, the criterion may be satisfied at 1106 after a predetermined amount of time expires since the start of the compression phase 1004, which may coincide with the start of the first hold period described above with reference to FIG. 10. In some examples, the criterion is satisfied at 1106 when the entity determines that a signal (e.g., a compression signal) indicates that a position (along the axis of extension/retraction) of the chest compressing mechanism 108 corresponds to a predetermined position, that an acceleration associated with the chest compression corresponds to a predetermined acceleration, that an electrical current associated with the motor of the mechanical chest compression device 102 corresponds to a predetermined electrical current, and/or that a rotation parameter associated with the motor corresponds to a predetermined parameter value.

If the criterion (or criteria) is not satisfied at 1106, the process 1100 follows the NO route from 1106 back to 1104, where the entity continues to evaluate the criterion (or criteria) until the criterion (or criteria) is satisfied at 1106, at which point, the process 1100 follows the YES route from 1106 to 1108. At 1108, the entity causes an auscultation device(s)/sensor(s) to detect a heart sound(s) in response to determining that the criterion (or criteria) is satisfied. For example, if the criterion is satisfied at 1106 when the entity determines that the chest compressing mechanism 108 (e.g., piston) has arrived at a second position (e.g., a target compression depth), the entity causes the auscultation device(s)/sensor(s) to detect a heart sound(s) in response to the chest compressing mechanism arriving at the second position (e.g., the target compression depth). As another example, if the criterion is satisfied at 1106 when the entity determines an expiration of a predetermined amount of time (e.g., 0.15 seconds) since a start of the compression phase 1004, the entity causes the auscultation device(s)/sensor(s) to detect a heart sound(s) in response to the expiration of the predetermined amount of time since a start of the compression phase 1004. Regardless of the criterion (or criteria) used, by waiting for the criterion (or criteria) to be satisfied before the heart sound is detected, the auscultation device(s)/sensor(s) can detect the heart sound at an optimal time where environment noise is mitigated, such as during the less noisy period 1012 (See FIG. 10) of the compression-decompression cycle 1002. This less noisy period 1012 may occur at the end of the compression phase 1004 (e.g., during the first hold period when the chest compressing mechanism 108 refrains from moving while the chest of the subject 104 remains in the compressed state, and before the chest compressing mechanism 108 starts moving at the beginning of the decompression phase 1006).

At 1110, the entity analyzes the heart sound detected by the auscultation device(s)/sensor(s). In some examples, the analyzing at 1110 includes analyzing an audible heart sound parameter(s) and/or a heart valve parameter(s). In some examples, the analyzing at 1110 includes analyzing an audio signal, such as an audible heart sound signal representing a heart sound detected by the auscultation device(s)/sensor(s), to identify a latter of two beating sounds (See e.g., beating sound, S₂, in FIG. 8).

At 1112, the entity determines, by analyzing the heart sound at 1110, whether the heart valve of the subject 104 is functioning or not. The operation(s) performed at 1112 may be the same as or similar to the operation(s) described above as being performed at 906 of the process 900, and those operation(s) will not be repeated here for the sake of brevity. If the entity determines, at 1112, that the heart valve of the subject 104 is not functioning (e.g., by determining that the aortic valve or the pulmonary valve of the heart closed incompletely during a compression-decompression cycle (e.g., during a compression phase or a decompression phase thereof), by determining that a heart valve parameter lacks a feature indicative of the aortic valve or the pulmonary valve closing completely during a compression-decompression cycle (e.g., during a compression phase or a decompression phase thereof), etc.), the process 1100 follows the NO route from 1112 to 1114.

At 1114, the entity dynamically changes, and/or causes a feedback signal(s) to be output as feedback for a rescuer to change, a compression position on the chest of the subject 104 during the CPR treatment. The operation(s) performed at 1114 may be the same as or similar to the operation(s) described above as being performed at 910 of the process 900, and those operation(s) will not be repeated here for the sake of brevity.

If the entity determines, at 1112, that the heart valve of the subject 104 is functioning (e.g., by determining that the aortic valve or the pulmonary valve of the heart closed completely during a compression-decompression cycle (e.g., during a compression phase or a decompression phase thereof), by determining that a heart valve parameter includes a feature indicative of the aortic valve or the pulmonary valve closing completely during a compression-decompression cycle (e.g., during a compression phase or a decompression phase thereof), etc.), the process 1100 follows the YES route from 1112 to 1116.

At 1116, in response to determining, at 1112, that the heart valve of the subject 104 is functioning, the entity may cause a feedback signal(s) to be output as feedback indicating that the position on the chest at which the chest compressions are being administered to the subject 104 is a correct position. The operation(s) performed at 1116 may be the same as or similar to the operation(s) described above as being performed at 916 of the process 900, and those operation(s) will not be repeated here for the sake of brevity.

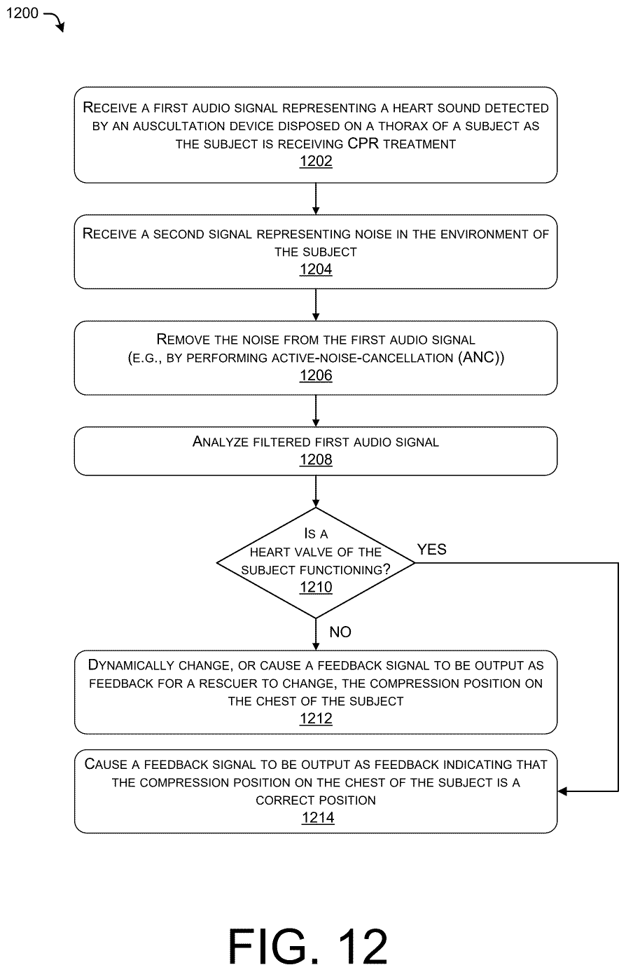

FIG. 12 illustrates an example process 1200 for filtering an audio signal representing a heart sound to remove unwanted noise from the audio signal, analyzing the filtered audio signal to determine whether a heart valve of a subject is functioning, and dynamically changing, and/or causing output of a feedback signal relating to, a compression position based at least in part on the analysis of the filtered audio signal. The process 1200 is performed by an entity including, for example, one or more devices of a CPR system, such as the mechanical chest compression device 102 of FIG. 1, the mechanical chest compression device 1600 of FIG. 16, one or more devices of the CPR feedback system 202 of FIG. 2, such as the defibrillator 208 of FIG. 2, the defibrillator 1500 of FIG. 15, the rescuer device 212 of FIG. 2, the CPR feedback device 206 of FIG. 2, a processor(s) of any of the aforementioned devices and/or a processor(s) of any other device(s) that is part of a CPR system.

At 1202, the entity receives a first audio signal representing a heart sound detected by an auscultation device(s)/sensor(s) disposed on a thorax (e.g., a chest or a back) of a subject 104 as the subject is receiving CPR treatment (e.g., as chest compressions are being administered to the subject 104). For example, an auscultation device(s)/sensor(s), such as the auscultation device 302(1), the auscultation device 302(2), and/or the auscultation device 402 described above may detect or otherwise capture an audible heart sound that is converted to an audible sound signal, such as the audible sound signal 802 shown in FIG. 8.

At 1204, the entity receives a second signal representing noise (or sound) in the environment where the CPR system (or a device(s) thereof) is located while the chest compressions are being administered to the subject 104. In some examples, the second signal received at 1204 is a second audio signal representing the environment sound detected by a microphone(s). In some examples, the microphone(s) that detected the environment sound is disposed on an external surface of a mechanical chest compression device 102, such as the microphone 308(1) described above. In some examples, the microphone(s) that detected the environment sound is disposed on an outer surface 408 of a CPR feedback device 206, such as the microphone 406 described above. In some examples, the second signal received at 1204 is a non-audio signal (e.g., a compression signal) indicative of a position of a chest compressing mechanism 108, a compression depth associated with the chest compressions, an acceleration associated with the chest compressions, an electrical current associated with a motor driving the chest compressing mechanism 108, and/or a rotation parameter associated with the motor.

At 1206, the entity removes the environment sound from the first audio signal received at 1202 to obtain a filtered first audio signal. The environment sound may represent any conceivable sound in the environment of the subject 104 who is receiving the CPR treatment, such as sound generated by the mechanical chest compression device 102, which may be administering automated chest compressions to the subject 104, sound generated by a ventilator for administering breaths to the subject 104, sound generated by rescuers and/or bystanders talking, background noise generated by crowds, vehicles, animals, etc. In some examples, the entity performs ANC to remove the environment sound detected by the auscultation device(s). That is, the auscultation device(s) may detect both the heart sound associated with the subject 104 and the environment sound, and, by determining the audio characteristics (e.g., frequency, amplitude, etc.) of the environment sound detected, for example, by a microphone other than the auscultation device(s), the entity can perform ANC to remove the environment sound from the first audio signal to obtain a filtered first audio signal that exhibits the heart sound with the environment sound reduced, if not eliminated, from the first audio signal.

At 1208, the entity analyzes the filtered first audio signal representing the heart sound detected by the auscultation device(s)/sensor(s). In some examples, the analyzing at 1208 includes analyzing an audible heart sound parameter(s) and/or a heart valve parameter(s). In some examples, the analyzing at 1208 includes analyzing the filtered first audio signal to identify a latter of two beating sounds (See e.g., beating sound, S₂, in FIG. 8).

At 1210, the entity determines, by analyzing the filtered first audio signal at 1208, whether the heart valve of the subject 104 is functioning or not. The operation(s) performed at 1210 may be the same as or similar to the operation(s) described above as being performed at 906 of the process 900, and those operation(s) will not be repeated here for the sake of brevity. If the entity determines, at 1210, that the heart valve of the subject 104 is not functioning (e.g., by determining that the aortic valve or the pulmonary valve of the heart closed incompletely during a compression-decompression cycle (e.g., during a compression phase or a decompression phase thereof), by determining that a heart valve parameter lacks a feature indicative of the aortic valve or the pulmonary valve closing completely during a compression-decompression cycle (e.g., during a compression phase or a decompression phase thereof), etc.), the process 1200 follows the NO route from 1210 to 1212.

At 1212, the entity dynamically changes, and/or causes a feedback signal(s) to be output as feedback for a rescuer to change, a compression position on the chest of the subject 104 during the CPR treatment. The operation(s) performed at 1212 may be the same as or similar to the operation(s) described above as being performed at 910 of the process 900, and those operation(s) will not be repeated here for the sake of brevity.

If the entity determines, at 1210, that the heart valve of the subject 104 is functioning (e.g., by determining that the aortic valve or the pulmonary valve of the heart closed completely during a compression-decompression cycle (e.g., during a compression phase or a decompression phase thereof), by determining that a heart valve parameter includes a feature indicative of the aortic valve or the pulmonary valve closing completely during a compression-decompression cycle (e.g., during a compression phase or a decompression phase thereof), etc.), the process 1200 follows the YES route from 1210 to 1214.

At 1214, in response to determining, at 1210, that the heart valve of the subject 104 is functioning, the entity may cause a feedback signal(s) to be output as feedback indicating that the position on the chest at which the chest compressions are being administered to the subject 104 is a correct position. The operation(s) performed at 1214 may be the same as or similar to the operation(s) described above as being performed at 916 of the process 900, and those operation(s) will not be repeated here for the sake of brevity.

Analysis of the heart valve function may provide feedback on the CPR quality and/or compression position, as described the examples above, and/or, in some examples, the information regarding CPR quality and/or compression position is used to predict the likelihood of ROSC for subject 104. In other words, in response to determining that the heart valve of the subject 104 is functioning (e.g., by determining that the aortic valve or the pulmonary valve closed completely), an entity may cause a feedback signal(s) to be output as feedback indicating that the likelihood of ROSC is high, since high quality CPR is provided and/or the position on the chest at which the chest compressions are being administered to the subject 104 is a correct position. In some examples, the feedback may indicate, to a rescuer, that the likelihood of ROSC for the subject 104 is high (e.g., if the user continues to provide chest compressions at the current position, since the current compression position is correct), and it is thus recommended that the compression position remain unchanged in order to maintain the high likelihood of ROSC for the subject 104, such as by a light emitting element(s) (e.g., LED(s)) emitting light of a particular color (e.g., green-colored light). Similarly, in response to determining that the heart valve of the subject 104 is not functioning (e.g., by determining that the aortic valve or the pulmonary valve of the heart closed incompletely during a compression-decompression cycle (e.g., during a compression phase or a decompression phase thereof), by determining that a heart valve parameter lacks a feature indicative of the aortic valve or the pulmonary valve closing completely during a compression-decompression cycle (e.g., during a compression phase or a decompression phase thereof), etc.), an entity may cause a feedback signal(s) to be output as feedback indicating that the likelihood of ROSC is low, since high quality CPR is not being provided and/or the position on the chest at which the chest compressions are being administered to the subject 104 is an incorrect position. In some examples, the feedback may indicate, to a rescuer, that the likelihood of ROSC for the subject 104 is low (e.g., if the user continues to provide chest compressions at the current position, since the current compression position is incorrect), and it is thus recommended to change the compression position in order to increase the likelihood of ROSC for the subject 104, such as by a light emitting element(s) (e.g., LED(s)) emitting light of a particular color (e.g., red-colored light).

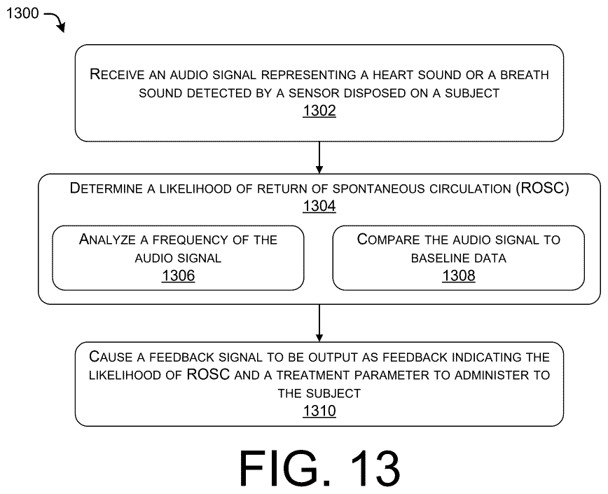

FIG. 13 illustrates an example process 1300 for identifying return of spontaneous circulation (ROSC) in a subject (e.g., the subject 104) based on analyzing an audio signal. In various examples, the process 1300 can be used to determine whether a heart valve of a subject is functioning. In various examples, the process 1300 can be used to determine whether the subject is breathing spontaneously (e.g., independent of chest compressions). The process 1300 is performed by an entity including, for example, one or more devices of a CPR system, such as the mechanical chest compression device 102 of FIG. 1, the mechanical chest compression device 1600 of FIG. 16, one or more devices of the CPR feedback system 202 of FIG. 2, such as the defibrillator 208 of FIG. 2, the defibrillator 1500 of FIG. 13, the rescuer device 212 of FIG. 2, the CPR feedback device 206 of FIG. 2, a processor(s) of any of the aforementioned devices and/or a processor(s) of any other device(s) that is part of a CPR system.

At 1302, the entity receives an audio signal representing a heart sound or a breath sound detected by one or more sensors disposed on the subject. The audio signal may indicate, for instance, heart valve motion, blood flow, lung motion, or airflow through the respiratory system of the subject. In various cases, the sensor(s) include a microphone, a piezoelectric transducer, an auscultation device, or the like. Examples of microphones include condenser microphones, contact microphones, micro-electro-mechanical systems (MEMS) microphones, air-coupled microphones, dynamic microphones, or the like. For instance, the sensor(s) may include an auscultation device disposed on a thorax (e.g., a chest or a back) of the subject as the subject is receiving CPR treatment (e.g., as chest compressions are being administered to the subject). The sensor(s) may be integrated into an electrode (e.g., an ECG electrode configured to detect an electrical signal generated by the heart of the subject). For example, an auscultation device(s)/sensor(s), such as the auscultation device 302(1), the auscultation device 302(2), and/or the auscultation device 402 described above may detect or otherwise capture an audible heart sound that is converted to an audible sound signal, such as the audible sound signal 802 shown in FIG. 8. In various cases, the sensor(s) are configured to detect a breath sound (e.g., a sound indicative of air moving through the respiratory system) of the subject. The sensor(s) may include an auscultation device configured to detect a lung sound within the body of the subject.

At 1304, the entity determines a likelihood of ROSC by analyzing the audio signal. In particular examples, the entity may analyze the audio signal in response to identifying administration of a defibrillation shock to the subject. As shown by sub-blocks 1306 and 1308, the operation(s) performed at 1304 may be based at least in part on one or more determinations. At 1306, for example, the entity analyzes a frequency spectrum of the audio signal in order to identify the presence of a periodic signature indicative of heart valve or lung motion. For instance, the entity may identify frequencies present in the audio signal and, in some cases, an amplitude associated with each of the frequencies. In various cases, a frequency of the periodic signature is within a pre-determined range associated with heart valve or lung motion. For instance, the pre-determined range may be based on a predicted pulse rate of the subject. In various examples in which chest compressions are being administered to the subject, the entity may apply a filter to remove a compression-related artifact from the audio signal. In some examples, the entity may identify the periodic signature during a pause in chest compressions. In some examples in which chest compressions are being administered to the subject, the entity identifies a periodic signature that is asynchronous with a signal artifact corresponding to the chest compressions. Accordingly, the entity may identify blood flow occurring independently of chest compressions administered to the subject.

At 1308, the entity compares the audio signal to baseline data in order to identify an audio signature indicative of ROSC. In some examples, the baseline data may be obtained from the subject at a prior time. For instance, the entity may store first baseline data during administration of chest compressions to the subject and second baseline data during a pause in the administration of chest compressions. Based on determining that the audio signal is indicative of chest compressions being administered to the subject, the entity may compare the audio signal to the first baseline data. In various examples, the entity identifies a difference between the audio signal and the baseline data. The entity may determine one or more frequencies that are present in the audio signal and absent in the baseline data. In some cases, the entity compares the frequencies to the pre-determined range associated with heart valve or lung motion.

In some examples, the baseline data includes baseline audio signatures of heart valve or lung motion. For instance, the baseline audio signatures may include or be indicative of heart valve motion of multiple individuals. In some cases, the baseline audio signatures are indicative of multiple individuals having normal heart valve or lung motion. In some cases, the baseline audio signatures are indicative of heart valve or lung motion during administration of CPR (e.g., chest compressions) to the multiple individuals or following the identification of ROSC in the multiple individuals. According to various implementations, the entity determines a presence of the baseline audio signatures in the audio signal in order to identify heart valve or lung motion of the subject that is indicative of ROSC. In examples in which the entity is analyzing breath sounds, the entity may determine ROSC based on identifying spontaneous breathing (e.g., airflow through the respiratory system of the subject that is independent from, or asynchronous with, chest compressions administered to the subject).

The entity may perform any or all of the operation(s) of 1308 alternatively or in addition to any or all of the operation(s) of 1306. For instance, based on identifying the baseline audio signature in the audio signal, the entity may determine whether a frequency of the baseline audio signature is within the pre-determined range associated with heart valve or lung motion. In some cases, the entity determines whether the baseline audio signature occurs asynchronously with a signal artifact corresponding to chest compressions administered to the subject. According to various examples, the entity may determine whether a heart valve of the subject is functioning properly based on analyzing the audio signal. For instance, the entity may determine whether an aortic valve or a pulmonary valve of a heart of the subject closed incompletely during a compression phase of a compression-decompression cycle of chest compressions administered to the subject.

In various examples, based on analyzing the heart valve or breath sounds, the entity may identify physiological damage or functional deterioration of the subject. For instance, the entity may identify a signature in the audio signal that is absent from baseline data previously obtained from the subject. The signature may be, for instance, coincident with chest compressions. In some cases, the entity determines that the signature is not associated with normal function of the circulatory or respiratory systems of the subject. The entity may identify, for instance, damage to the thorax of the subject based on identifying the signature in the audio signal indicative of heart valve motion of the subject. In some examples, the entity identifies physiological damage based on comparing the signature over time (e.g., a signature at a first time point and a signature at a second time point). In various cases, the entity identifies a change in lung compliance that, for instance, may be indicative of functional deterioration of the lungs of the subject based on analyzing the breath sounds of the subject.

At 1310, the entity may cause a feedback signal(s) to be output as feedback indicating the likelihood of ROSC. In some examples, the feedback signal(s) include feedback indicating a treatment parameter to administer to the subject. The treatment parameter may include one or more of a position on a chest of the subject, a frequency, or a depth of chest compressions to administer to the subject. In some cases, the treatment parameter includes an indication to pause, cease, or initiate administration of chest compressions to the subject. In various instances, the entity causes the feedback signal(s) to be output based on analyzing one or more additional parameters of the subject. For instance, the audio signal may be indicative of heart valve motion of the subject, and the entity may receive an additional signal indicative of a breath sound, a pulse, or another physiological parameter of the subject. The entity may analyze the additional signal in order to determine the likelihood of ROSC and/or the treatment parameter. For example, the entity may lower the likelihood of ROSC or repeat the process 1300 based on determining that, while the audio signal is indicative of proper function of the heart valves of the subject, the additional signal is not indicative of ROSC.

In various cases, the feedback is outputted as at least one of a visual signal, an audio signal or a haptic signal. For instance, the feedback may include text, such as a number and/or words indicating the likelihood of ROSC. The feedback may be indicated using color. For instance, an LED emitting red-colored light or red text on a visual display may indicate that a high likelihood of ROSC (e.g., the likelihood of ROSC being above a threshold) and/or a change in a treatment parameter based on the high likelihood of ROSC.

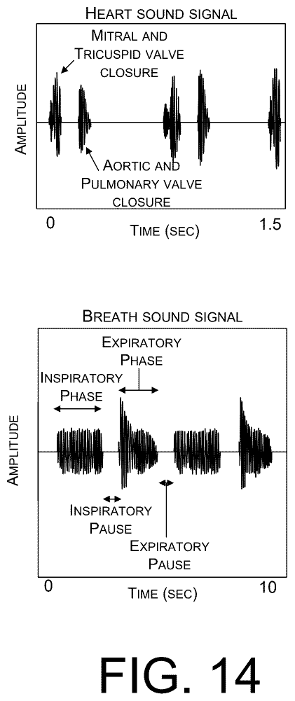

FIG. 14 illustrates example heart valve sounds 1402 and breath sounds 1404 that may be detected using the sensor(s), such as the auscultation device 302(1), the auscultation device 302(2), and/or the auscultation device 402 described above. The example heart valve and breath sounds may be identified or generated, for instance, by the entity using the process 1300.

According to various implementations, the heart valve and breath sounds 1402 and 1404 illustrated in FIG. 14 are generated based on processing the data generated by the sensor(s). For instance, a signal indicative of heart valve sounds detected by the sensor(s) may be filtered in order to identify a signature having a frequency within a pre-determined range associated with heart valve motion (e.g., a predicted frequency of periodic mitral and tricuspid valve closure). In some examples, the heart valve and breath sounds 1402 and 1404 are detected during a pause in chest compressions.

In various examples, the heart valve and breath sounds 1402 and 1404 are analyzed to determine audio signatures associated with heart valve motion or air flow through the respiratory system. For instance, the heart valve sounds 1402 may represent an average of signals detected from a population of individuals. The signal indicating the expiratory phase may be stored as an audio signature and compared to an audio signal from a subject in order to identify spontaneous breathing of the subject. Based on identifying spontaneous breathing, an entity (e.g., the entity described above with reference to FIG. 13) may determine a likelihood of ROSC in the subject. While FIG. 14 illustrates example heart valve sounds 1402 and breath sounds 1404, implementations of the present disclosure are not so limited. Some individuals, including healthy individuals, individuals who have experienced cardiac arrest, or individuals with a cardiac condition, may have different heart valve sounds and/or breath sounds than those illustrated in FIG. 14.

FIG. 15 illustrates an example of an external defibrillator 1500 configured to perform various functions described herein. For example, the external defibrillator 1500 is the defibrillator 208 described above with reference to FIG. 2.

The external defibrillator 1500 includes an electrocardiogram (ECG) port 1502 connected to multiple ECG wires 1504. In some cases, the ECG wires 1504 are removeable from the ECG port 1502. For instance, the ECG wires 1504 are plugged into the ECG port 1502 via connectors. The ECG wires 1504 are connected to ECG electrodes 1506, respectively. In various implementations, the ECG electrodes 1506 are disposed on different locations on an individual 1508. For example, the individual 1508 is the subject 104 described above. A detection circuit 1510 is configured to detect relative voltages between the ECG electrodes 1506. These voltages are indicative of the electrical activity of the heart of the individual 1508.

In various implementations, the ECG electrodes 1506 are in contact with the different locations on the skin of the individual 1508. In some examples, a first one of the ECG electrodes 1506 is placed on the skin between the heart and right arm of the individual 1508, a second one of the ECG electrodes 1506 is placed on the skin between the heart and left arm of the individual 1508, and a third one of the ECG electrodes 1506 is placed on the skin between the heart and a leg (either the left leg or the right leg) of the individual 1508. In these examples, the detection circuit 1510 is configured to measure the relative voltages between the first, second, and third ECG electrodes 1506. Respective pairings of the ECG electrodes 1506 are referred to as “leads,” and the voltages between the pairs of ECG electrodes 1506 are known as “lead voltages.” In some examples, more than three ECG electrodes 1506 are included, such that 5-lead or 12-lead ECG signals are detected by the detection circuit 1510.

The detection circuit 1510 includes at least one analog circuit, at least one digital circuit, or a combination thereof. The detection circuit 1510 receives the analog electrical signals from the ECG electrodes 1506, via the ECG port 1502 and the ECG wires 1504. In some cases, the detection circuit 1510 includes one or more analog filters configured to filter noise and/or artifact from the electrical signals. The detection circuit 1510 includes an analog-to-digital converter (ADC) in various examples. The detection circuit 1510 generates a digital signal indicative of the analog electrical signals from the ECG electrodes 1506. This digital signal can be referred to as an “ECG signal” or an “ECG.”

In some cases, the detection circuit 1510 further detects an electrical impedance between at least one pair of the ECG electrodes 1506. For example, the detection circuit 1510 includes, or otherwise controls, a power source that applies a known voltage (or current) across a pair of the ECG electrodes 1506 and detects a resultant current (or voltage) between the pair of the ECG electrodes 1506. In various cases, the current is applied via a high-frequency (e.g., 20 kHz) carrier signal. The impedance is generated based on the applied signal (voltage or current) and the resultant signal (current or voltage). In various cases, the impedance corresponds to respiration of the individual 1508, chest compressions performed on the individual 1508, and other physiological states of the individual 1508. In various examples, the detection circuit 1510 includes one or more analog filters configured to filter noise and/or artifact from the resultant signal. The detection circuit 1510 generates a digital signal indicative of the impedance using an ADC. This digital signal can be referred to as an “impedance signal” or an “impedance.”

The detection circuit 1510 provides the ECG signal and/or the impedance signal one or more processors 1512 in the external defibrillator 1500. In some implementations, the processor(s) 1512 includes a central processing unit (CPU), a graphics processing unit (GPU), both CPU and GPU, or other processing unit or component known in the art.

The processor(s) 1512 is operably connected to memory 1514. In various implementations, the memory 1514 is volatile (such as random access memory (RAM)), non-volatile (such as read only memory (ROM), flash memory, etc.) or some combination of the two. The memory 1514 stores instructions that, when executed by the processor(s) 1512, causes the processor(s) 1512 to perform various operations. In various examples, the memory 1514 stores methods, threads, processes, applications, objects, modules, any other sort of executable instruction, or a combination thereof. In some cases, the memory 1514 stores files, databases, or a combination thereof. In some examples, the memory 1514 includes, but is not limited to, RAM, ROM, electrically erasable programmable read-only memory (EEPROM), flash memory, or any other memory technology. In some examples, the memory 1514 includes one or more of compact disc-ROMs (CD-ROMs), digital versatile discs (DVDs), content-addressable memory (CAM), or other optical storage, magnetic cassettes, magnetic tape, magnetic disk storage or other magnetic storage devices, or any other medium which can be used to store the desired information and which can be accessed by the processor(s) 1512 and/or the external defibrillator 1500. In some cases, the memory 1514 at least temporarily stores the ECG signal and/or the impedance signal.

In various examples, the memory 1514 includes a detector 1516, which causes the processor(s) 1512 to determine, based on the ECG signal and/or the impedance signal, whether the individual 1508 is exhibiting a particular heart rhythm. For instance, the processor(s) 1512 determines whether the individual 1508 is experiencing a shockable rhythm that is treatable by defibrillation. Examples of shockable rhythms include ventricular fibrillation (VF) and ventricular tachycardia (V-Tach). In some examples, the processor(s) 1512 determines whether any of a variety of different rhythms (e.g., asystole, sinus rhythm, atrial fibrillation (AF), etc.) are present in the ECG signal.

The processor(s) 1512 is operably connected to one or more input devices 1518 and one or more output devices 1520. Collectively, the input device(s) 1518 and the output device(s) 1520 function as an interface between a user and the defibrillator 1500. The input device(s) 1518 is configured to receive an input from a user and includes at least one of a keypad, a cursor control, a touch-sensitive display, a voice input device (e.g., a microphone), a haptic feedback device (e.g., a gyroscope), or any combination thereof. The output device(s) 1520 includes at least one of a display, a speaker, a haptic output device, a printer, or any combination thereof. In various examples, the processor(s) 1512 causes a display among the output device(s) 1520 to visually output a waveform of the ECG signal and/or the impedance signal. In some implementations, the input device(s) 1518 includes one or more touch sensors, the output device(s) 1520 includes a display screen, and the touch sensor(s) are integrated with the display screen. Thus, in some cases, the external defibrillator 1500 includes a touchscreen configured to receive user input signal(s) and visually output physiological parameters, such as the ECG signal and/or the impedance signal.

In some examples, the memory 1514 includes an advisor 1522, which, when executed by the processor(s) 1512, causes the processor(s) 1512 to generate advice and/or control the output device(s) 1520 to output the advice to a user (e.g., a rescuer). In some examples, the processor(s) 1512 provides, or causes the output device(s) 1520 to provide, an instruction to perform CPR on the individual 1508. In some cases, the processor(s) 1512 evaluates, based on the ECG signal, the impedance signal, or other physiological parameters, CPR being performed on the individual 1508 and causes the output device(s) 1520 to provide feedback about the CPR in the instruction. According to some examples, the processor(s) 1512, upon identifying that a shockable rhythm is present in the ECG signal, causes the output device(s) 1520 to output an instruction and/or recommendation to administer a defibrillation shock to the individual 1508.

The memory 1514 also includes an initiator 1524 which, when executed by the processor(s) 1512, causes the processor(s) 1512 to control other elements of the external defibrillator 1500 in order to administer a defibrillation shock to the individual 1508. In some examples, the processor(s) 1512 executing the initiator 1524 selectively causes the administration of the defibrillation shock based on determining that the individual 1508 is exhibiting the shockable rhythm and/or based on an input from a user (received, e.g., by the input device(s) 1518). In some cases, the processor(s) 1512 causes the defibrillation shock to be output at a particular time, which is determined by the processor(s) 1512 based on the ECG signal and/or the impedance signal.

In various cases, the memory 1514 includes a compression position component 1527 that, when executed by the processor(s) 1512, causes the defibrillator 1500 to pair with and/or authenticate the CPR feedback device 206 and/or the rescuer device 212 of FIG. 2, cause a feedback signal(s) to be output as feedback for a rescuer to change the position on the chest of the subject at which hands of the rescuer are placed for manually administering the chest compressions, and/or causes performance of the techniques and/or processes described herein, such as the process 900, the process 1100, the process 1200, and/or any other technique or process described herein.

The processor(s) 1512 is operably connected to a charging circuit 1523 and a discharge circuit 1525. In various implementations, the charging circuit 1523 includes a power source 1526, one or more charging switches 1528, and one or more capacitors 1530. The power source 1526 includes, for instance, a battery. The processor(s) 1512 initiates a defibrillation shock by causing the power source 1526 to charge at least one capacitor among the capacitor(s) 1530. For example, the processor(s) 1512 activates at least one of the charging switch(es) 1528 in the charging circuit 1523 to complete a first circuit connecting the power source 1526 and the capacitor to be charged. Then, the processor(s) 1512 causes the discharge circuit 1525 to discharge energy stored in the charged capacitor across a pair of defibrillation electrodes 1534, which are in contact with the individual 1508. For example, the processor(s) 1512 deactivates the charging switch(es) 1528 completing the first circuit between the capacitor(s) 1530 and the power source 1526, and activates one or more discharge switches 1532 completing a second circuit connecting the charged capacitor 1530 and at least a portion of the individual 1508 disposed between defibrillation electrodes 1534. In various cases, more than two defibrillation electrodes 1534 are disposed on the skin of the individual 1508, which define multiple shock vectors.

The energy is discharged from the defibrillation electrodes 1534 in the form of a defibrillation shock. For example, the defibrillation electrodes 1534 are connected to the skin of the individual 1508 and located at positions on different sides of the heart of the individual 1508, such that the defibrillation shock is applied across the heart of the individual 1508. The defibrillation shock, in various examples, depolarizes a significant number of heart cells in a short amount of time. The defibrillation shock, for example, interrupts the propagation of the shockable rhythm (e.g., VF or VT) through the heart. In some examples, the defibrillation shock is 200 J or greater with a duration of about 0.015 seconds. In some cases, the defibrillation shock has a multiphasic (e.g., biphasic) waveform. The discharge switch(es) 1532 are controlled by the processor(s) 1512, for example. In various implementations, the defibrillation electrodes 1534 are connected to defibrillation wires 1536. The defibrillation wires 1536 are connected to a defibrillation port 1538, in implementations. According to various examples, the defibrillation wires 1536 are removable from the defibrillation port 1538. For example, the defibrillation wires 1536 are plugged into the defibrillation port 1538.

In various implementations, the processor(s) 1512 is operably connected to one or more transceivers 1540 that transmit and/or receive data over one or more communication networks 1542. For example, the transceiver(s) 1540 includes a network interface card (NIC), a network adapter, a local area network (LAN) adapter, or a physical, virtual, or logical address to connect to the various external devices and/or systems. In various examples, the transceiver(s) 1540 includes any sort of wireless transceivers capable of engaging in wireless communication (e.g., radio frequency (RF) communication). For example, the communication network(s) 1542 includes one or more wireless networks that include a 3^{rd} Generation Partnership Project (3GPP) network, such as a Long Term Evolution (LTE) radio access network (RAN) (e.g., over one or more LTE bands), a New Radio (NR) RAN (e.g., over one or more NR bands), or a combination thereof. In some cases, the transceiver(s) 1540 includes other wireless modems, such as a modem for engaging in WI-FI®, WIGIG®, WIMAX®, BLUETOOTH®, or infrared communication over the communication network(s) 1542.

The defibrillator 1500 is configured to transmit and/or receive data (e.g., ECG data, impedance data, data indicative of one or more detected heart rhythms of the individual 1508, data indicative of one or more defibrillation shocks administered to the individual 1508, data associated with CPR treatment the individual 1508 is receiving, etc.) with one or more external devices 1544 via the communication network(s) 1542. The external devices 1544 include, for instance, mobile devices (e.g., mobile phones, smart watches, etc.), Internet of Things (IoT) devices, medical devices (e.g., the mechanical chest compression device 102, 1600), computers (e.g., laptop devices, servers, etc.), or any other type of computing device configured to communicate over the communication network(s) 1542. In some examples, the external device(s) 1544 is located remotely from the defibrillator 1500, such as at a remote clinical environment (e.g., a hospital). According to various implementations, the processor(s) 1512 causes the transceiver(s) 1540 to transmit data to the external device(s) 1544. In some cases, the transceiver(s) 1540 receives data from the external device(s) 1544 and the transceiver(s) 1540 provide the received data to the processor(s) 1512 for further analysis. In some examples, the defibrillator 1500 includes one or more ports 1541 to physically couple to one or more of the external device(s) 1544 via a wired connection(s). In some examples, the external device(s) 1544 include one or more sensors configured to detect a physiological parameter of the individual 1508. Accordingly, the defibrillator 1500 may include one or more ports 1541 to connected to such sensor(s) via a wired connection(s) (e.g., a cable(s)), such as a blood pressure measurement port(s) configured to connect to a blood pressure sensor(s), an audio port(s) configured to facilitate a wired connection to an external microphone(s), and/or the like.

In various implementations, the external defibrillator 1500 also includes a housing 1546 that at least partially encloses other elements of the external defibrillator 1500. For example, the housing 1546 encloses the detection circuit 1510, the processor(s) 1512, the memory 1514, the charging circuit 1523, the transceiver(s) 1540, or any combination thereof. In some cases, the input device(s) 1518 and output device(s) 1520 extend from an interior space at least partially surrounded by the housing 1546 through a wall of the housing 1546. In various examples, the housing 1546 acts as a barrier to moisture, electrical interference, and/or dust, thereby protecting various components in the external defibrillator 1500 from damage.

In some implementations, the external defibrillator 1500 is an automated external defibrillator (AED) operated by an untrained user (e.g., a bystander, layperson, etc.) and can be operated in an automatic mode. In automatic mode, the processor(s) 1512 automatically identifies a rhythm in the ECG signal, makes a decision whether to administer a defibrillation shock, charges the capacitor(s) 1530, discharges the capacitor(s) 1530, or any combination thereof. In some cases, the processor(s) 1512 controls the output device(s) 1520 to output (e.g., display) a simplified user interface to the untrained user. For example, the processor(s) 1512 refrains from causing the output device(s) 1520 to display a waveform of the ECG signal and/or the impedance signal to the untrained user, in order to simplify operation of the external defibrillator 1500.

In some examples, the external defibrillator 1500 is a monitor-defibrillator utilized by a trained user (e.g., a clinician, an emergency responder, etc.) and can be operated in a manual mode or the automatic mode. When the external defibrillator 1500 operates in manual mode, the processor(s) 1512 cause the output device(s) 1520 to display a variety of information that may be relevant to the trained user, such as waveforms indicating the ECG data and/or impedance data, notifications about detected heart rhythms, and the like.

FIG. 16 illustrates a mechanical chest compression device 1600 configured to perform various functions described herein. For example, the mechanical chest compression device 1600 is the mechanical chest compression device 102 described in FIG. 1.

In various implementations, the mechanical chest compression device 1600 includes a compressor 1602 that is operatively coupled to a motor 1604. For example, the compressor 1602 is the chest compressing mechanism 108 described in FIG. 1. The compressor 1602 physically administers a force to the chest of a subject 1606 that compresses the chest of the subject 1606. For example, the subject 1606 is the subject 104 described in FIG. 1. In some examples, the compressor 1602 includes at least one piston 1605 that periodically moves between two or more positions (e.g., a compressed position and a release position) at a compression frequency. For example, when the piston 1605 is positioned on the chest of the subject 1606, the piston 1605 compresses the chest when the piston 1605 is moved into the compressed position. A suction cup 1607 may be positioned on a tip of the piston 1605, such that the suction cup 1607 contacts the chest of the subject 1606 during operation. In various cases, the compressor 1602 includes a band (e.g., a load-distributing band) that periodically tightens to a first tension and loosens to a second tension at a compression frequency. For instance, when the band is disposed around the chest of the subject 1606, the band compresses the chest when the band tightens.

The motor 1604 is configured to convert electrical energy stored in a power source 1608 into mechanical energy that moves and/or tightens the compressor 1602, thereby causing the compressor 1602 to administer the force to the chest of the subject 1606. In various implementations, the power source 1608 is portable. For instance, the power source 1608 includes at least one rechargeable (e.g., lithium-ion) battery. In some cases, the power source 1608 supplies electrical energy to one or more elements of the mechanical chest compression device 1600 described herein.

In various cases, the mechanical chest compression device 1600 includes a support 1610 that is physically coupled to the compressor 1602, such that the compressor 1602 maintains a position relative to the subject 1606 during operation. In some implementations, the support 1610 is physically coupled to a backplate 1612, cot, or other external structure with a fixed position relative to the subject 1606. In some examples, the support 1610 includes a pair of legs that are configured to connect to the backplate 1612 at respective sides of the backplate 1612. According to some cases, the support 1610 is physically coupled to a portion of the subject 1606, such as wrists of the subject 1606.

The operation of the mechanical chest compression device 1600 may be controlled by at least one processor 1614. In various implementations, the motor 1604 is communicatively coupled to the processor(s) 1614. Specifically, the processor(s) 1614 is configured to output a control signal to the motor 1604 that causes the motor 1604 to actuate the compressor 1602. For instance, the motor 1604 causes the compressor 1602 to administer the compressions to the subject 1606 based on the control signal. In some cases, the control signal indicates one or more treatment parameters (sometimes referred to herein as “chest compression parameters”) of the compressions. Examples of treatment parameters include a frequency, timing, depth, force, position, velocity, and acceleration of the compressor 1602 administering the compressions. According to various cases, the control signal causes the motor 1604 to cease compressions and/or to hold the compressor 1602 in a fixed position for a hold period.

In various implementations, the mechanical chest compression device 1600 includes at least one transceiver 1616 configured to communicate with at least one external device 1618 over one or more communication networks 1620. Any communication network described herein can be included in the communication network(s) 1620 illustrated in FIG. 16. The external device(s) 1618, for example, includes at least one of a monitor-defibrillator, an AED, an ECMO device, a ventilation device, a patient monitor, a mobile phone, a server, or a computing device, or any other medical device. In some implementations, the transceiver(s) 1616 is configured to communicate with the external device(s) 1618 by transmitting and/or receiving signals wirelessly. For example, the transceiver(s) 1616 includes a NIC, a network adapter, a LAN adapter, or a physical, virtual, or logical address to connect to the various external devices and/or systems. In various examples, the transceiver(s) 1616 includes any sort of wireless transceivers capable of engaging in wireless communication (e.g., RF communication). For example, the communication network(s) 1620 includes one or more wireless networks that include a 3GPP network, such as an LTE RAN (e.g., over one or more LTE bands), an NR RAN (e.g., over one or more NR bands), or a combination thereof. In some cases, the transceiver(s) 1616 includes other wireless modems, such as a modem for engaging in WI-FI®, WIGIG®, WIMAX®, BLUETOOTH®, or infrared communication over the communication network(s) 1620. The signals, in various cases, encode data in the form of data packets, datagrams, or the like. In some cases, the signals are transmitted as compressions are being administered by the mechanical chest compression device 1600 (e.g., for real-time feedback by the external device(s) 1618), after compressions are administered by the mechanical chest compression device 1600 (e.g., for post-event review at the external device 1618), or a combination thereof. In some examples, the mechanical chest compression device 1600 includes one or more ports 1641 to physically couple to one or more of the external device(s) 1618 via a wired connection(s).

In various cases, the processor(s) 1614 generates the control signal based on data encoded in the signals received from the external device(s) 1618. For instance, the signals include an instruction to initiate the compressions, and the processor(s) 1614 instructs the motor 1604 to begin actuating the compressor 1602 in accordance with the signals.

In some cases, the mechanical chest compression device 1600 includes at least one input device 1622. In various examples, the input device(s) 1622 is configured to receive an input signal from a user 1624, who may be a rescuer treating the subject 1606. Examples of the input device(s) 1622 include, for instance, a keypad, a cursor control, a touch-sensitive display, a voice input device (e.g., a microphone), a haptic feedback device (e.g., a gyroscope), or any combination thereof. In various implementations, the processor(s) 1614 generates the control signal based on the input signal. For instance, the processor(s) 1614 generates the control signal to adjust a frequency of the compressions based on the mechanical chest compression device 1600 detecting a selection by the user 1624 of a user interface element displayed on a touchscreen or detecting the user 1624 pressing a button integrated with an external housing of the mechanical chest compression device 1600.

According to some examples, the input device(s) 1622 include one or more sensors. The sensor(s), for example, is configured to detect a physiological parameter of the subject 1606. In some implementations, the sensor(s) is configured to detect a state parameter of the mechanical chest compression device 1600, such as a position of the compressor 1602 with respect to the subject 1606 or the backplate 1612, a force administered by the compressor 1602 on the subject 1606, a force administered onto the backplate 1612 by the body of the subject 1606 during a compression, or the like. According to some implementations, the signals transmitted by the transceiver(s) 1616 indicate the physiological parameter(s) and/or the state parameter(s). In some examples, the sensor(s) include an auscultation device(s)/sensor(s) (e.g., a microphone(s)) configured to capture an audible sound signal 802 (e.g., an audible heart sound) during CPR. For instance, the sensor(s) are disposed on surfaces of the backplate 1612, the compressor 1602 (e.g., the distal end of the suction cup 1607), or a combination thereof.

The mechanical chest compression device 1600 further includes at least one output device 1625, in various implementations. Examples of the output device(s) 1625 include, for instance, least one of a display (e.g., a projector, an LED screen, etc.), a speaker, a haptic output device, a printer, a light emitting element(s) (LED), or any combination thereof. In some implementations, the output device(s) 1625 include a screen configured to display various parameters detected by and/or reported to the mechanical chest compression device 1600, a charge level of the power source 1608, a timer indicating a time since compressions were initiated or paused, and other relevant information.

The mechanical chest compression device 1600 further includes memory 1626. In various implementations, the memory 1626 is volatile (such as random access memory (RAM)), non-volatile (such as read only memory (ROM), flash memory, etc.) or some combination of the two. The memory 1626 stores instructions that, when executed by the processor(s) 1614, causes the processor(s) 1614 to perform various operations. In various examples, the memory 1626 stores methods, threads, processes, applications, objects, modules, any other sort of executable instruction, or a combination thereof. In some cases, the memory 1626 stores files, databases, or a combination thereof. In some examples, the memory 1626 includes, but is not limited to, RAM, ROM, EEPROM, flash memory, or any other memory technology. In some examples, the memory 1626 includes one or more of CD-ROMs, DVDs, CAM, or other optical storage, magnetic cassettes, magnetic tape, magnetic disk storage or other magnetic storage devices, or any other medium which can be used to store the desired information. In various cases, the memory 1626 stores instructions, programs, threads, objects, data, or any combination thereof, that cause the processor(s) 1614 to perform various functions. In various cases, the memory 1626 stores one or more parameters that are detected by the mechanical chest compression device 1600 and/or reported to the mechanical chest compression device 1600.

In various cases, the memory 1626 includes a compression position component 1627 that, when executed by the processor(s) 1614, causes the compressor 1602 to change a position on the chest of the subject at which future chest compressions are to be administered to the subject. In some examples, the compression position component 1627, when executed by the processor(s) 1614, causes a feedback signal to be output as feedback to change a position on a chest of the subject at which future chest compressions are to be administered to the subject, and/or causes performance of the techniques and/or processes described herein, such as the process 900, the process 1100, the process 1200, and/or any other technique or process described herein.

It should be noted that other input, signals, and data may be used to further validate the analysis and determinations made in the techniques and methods described above, e.g., with the use of end tidal CO2 measurements.

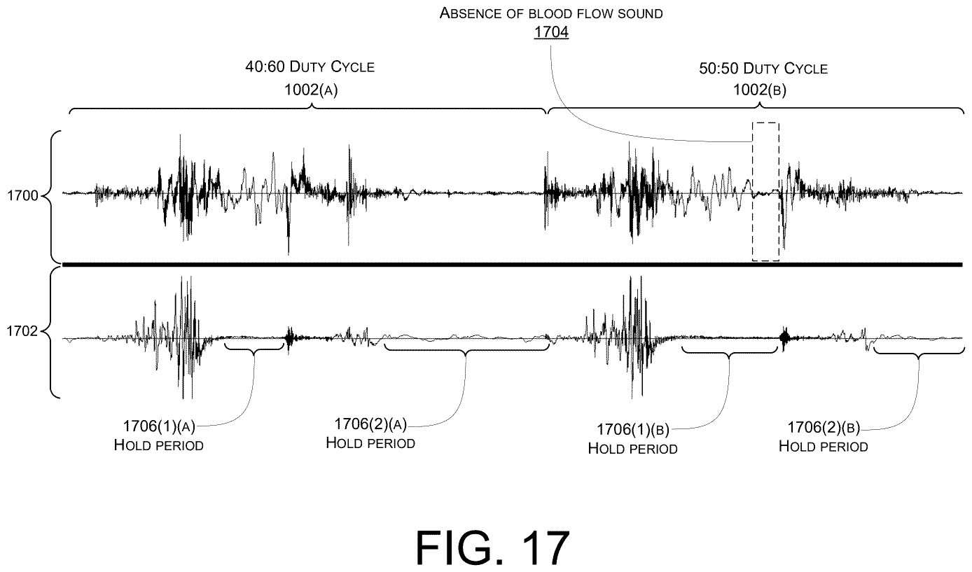

FIG. 17 illustrates audio signals generated during administration of CPR to a subject 104 by a mechanical chest compression device 102. For example, the subject 104 may be in cardiac arrest (e.g., in VF) and the mechanical chest compression device 102 may be secured around the subject 104 and may be administering CPR to the subject 104 when the audio signals in FIG. 17 are generated. A first audio signal 1700 depicted in FIG. 17 is generated using an auscultation device(s) 302 disposed on a thorax of the subject 104. For example, the first audio signal 1700 can be generated using the auscultation device 302(1) disposed on the chest of the subject 104 near the heart, and/or using the auscultation device 302(2) disposed on the back of the subject 104 near the heart. Accordingly, at least a portion(s) of the first audio signal 1700 may be indicative of heart sounds of the subject 104 that occur during ongoing CPR. It is to be appreciated that the first audio signal 1700 is merely an example, and that, depending on the characteristics of the auscultation device(s) 302 (e.g., microphone, digital stethoscope, etc.), and/or depending on the frequency range selected in the audio recording, and/or depending on the frequency spectrum analyzed, more detailed (or less detailed) heart sound information may be exhibited in the first audio signal 1700.

A second audio signal 1702 depicted in FIG. 17 is generated at the same time as the first audio signal 1700, and is generated using a microphone(s) in an environment of the subject 104. For example, the second audio signal 1702 can be generated using the microphone 308(1) disposed on the main portion 310 of the mechanical chest compression device 102. Accordingly, the second audio signal 1702 may be indicative of sounds in the vicinity of the subject 104 (e.g., the sound(s) made by the operation of the mechanical chest compression device 102, such as the sound of the motor 1604 during movement of the chest compressing mechanism 108 (e.g., piston 1605)).

The audio signals 1700, 1702 (e.g., recordings) are shown as spanning the length of two sequential compression-decompression cycles 1002, which include a first compression-decompression cycle 1002(A) followed by a second, subsequent compression-decompression cycle 1002(B). The first sound sequence exhibited in the second audio signal 1702 represents the sound of the mechanical chest compression device 102 when the chest compressing mechanism 108 (e.g., piston 1605) is moving downwards (e.g. during the initial portion of the compression phase 1004). When this first sound sequence has ended, the chest compressing mechanism 108 (e.g., piston 1605) of the mechanical chest compression device 102 has reached its target/end position during the compression phase 1004 (e.g. the chest has been compressed 53 mm from the start position) indicating the start of a first hold period 1706(1)(A) in which the chest compressing mechanism 108 (e.g., piston 1605) and the chest are at the end position where they are being held down until the start of the decompression phase 1006.

After this first hold period 1706(1)(A), a second sound sequence is exhibited in the second audio signal 1702. This second sound sequence represents the sound of the mechanical chest compression device 102 when the chest compressing mechanism 108 (e.g., piston 1605) is moving upwards (e.g. during the initial portion of the decompression phase 1006). When this second sound sequence has ended, the chest compressing mechanism 108 (e.g., piston 1605) of the mechanical chest compression device 102 has reached its top position (e.g., the starting position at 0 mm in the waveform 1000 shown in FIG. 10) during the decompression phase 1006 indicating the start of a second hold period 1706(2)(A) in which the chest compressing mechanism 108 (e.g., piston 1605) and the chest are at the start position where they are being held up until the start of the next compression phase 1004 of the second, subsequent compression-decompression cycle 1002(B). The latter part of the second audio signal 1702 during the second compression-decompression cycle 1002(B) includes a third sound sequence and a fourth sound sequence. These third and fourth sound sequences are similar to the first and second sound sequences exhibited during the first compression-decompression cycle 1002(A). For example, a third sound sequence representing downward movement of the chest compressing mechanism 108 (e.g., piston 1605) of the mechanical chest compression device 102 precedes a first hold period 1706(1)(B) at the end of the compression phase 1004 of the second compression-decompression cycle 1002(B), and a fourth sound sequence representing upward movement of the chest compressing mechanism 108 (e.g., piston 1605) of the mechanical chest compression device 102 precedes a second hold period 1706(2)(B) at the end of the decompression phase 1006 of the second compression-decompression cycle 1002(B).

The four sound sequences, which represent the sounds made by the mechanical chest compression device 102 over the two compression-decompression cycles 1002(A) and 1002(B), are also exhibited in the first audio signal 1700. The four sound sequences occur in the first audio signal 1700 at the same respective times as they occur in the second audio signal 1702. In addition to these four device-created sound sequences, the first audio signal 1700 also exhibits internal body sounds associated with the heart of the subject 104, and, more specifically, the first audio signal 1700 exhibits the sound of flowing blood as the blood is ejected out from the heart during the compression phase 1004 of each compression-decompression cycle 1002. For example, during the first hold period 1706(1)(A) of the compression phase 1004 of the first compression-decompression cycle 1002(A) (e.g., after the chest compressing mechanism 108 (e.g., piston 1605) of the mechanical chest compression device 102 has reached its target/end position during the compression phase 1004), a heart sound signal is exhibited in the first audio signal 1700. This heart sound signal is exhibited in the first audio signal 1700 until the start of the decompression phase 1006 of the first compression-decompression cycle 1002(A) (e.g., this heart sound signal is present between the two time points S1 and S2 in FIG. 8 during which blood is being ejected from the heart). Thus, this heart sound signal is the sound created by the flow of blood (e.g., turbulent flow of blood) out from the heart when the blood is ejected from the ventricle(s) caused by the compression of the ventricle(s) during the compression phase 1004 of the first compression-decompression cycle 1002(A). Accordingly, the heart sound signal exhibited in the first audio signal 1700 during the first hold period 1706(1)(A) may represent a blood flow parameter.

Now looking at the second half of the first audio signal 1700, during the second compression-decompression cycle 1002(B), a similar heart sound signal is exhibited in the first audio signal 1700 during the first hold period 1706(1)(B) of the compression phase 1004 of the second compression-decompression cycle 1002(B). In contrast with the similar heart sound signal exhibited during the first compression-decompression cycle 1002(A), the heart sound signal exhibited during the second compression-decompression cycle 1002(B) disappears prior to the start of the decompression phase 1006 of the second compression-decompression cycle 1002(B), as indicated by the highlighted area in FIG. 17 indicating the absence of blood flow sound 1704. In other words, the absence of blood flow sound 1704 during the latter part of the first hold period 1706(1)(B) of the compression phase 1004 of the second compression-decompression cycle 1002(B) may indicate that blood flow out of the heart has stopped for a period of time at the end of the compression phase 1004 prior to the beginning of the decompression phase 1006. Ejection of blood from the heart likely stopped towards the end of the first hold period 1706(1)(B) due to the closing of the aortic valve at the time point of the beginning of the highlighted area indicating the absence of blood flow sound 1704. Thus, the heart sound signal exhibited in the first audio signal 1700 during the first hold period 1706(1)(B) may represent a blood flow parameter, which can be used to detect the time point of the closing of the aortic valve of the heart of the subject 104 who is receiving CPR treatment via the mechanical chest compression device 102 due to the absence of blood flow sound 1704.

One reason why the aortic valve closure is detected in the first audio signal 1700 during the second compression-decompression cycle 1002(B) and is not detected during the first compression-decompression cycle 1002(A) is because two different duty cycles are implemented by the mechanical chest compression device 102 during the respective compression-decompression cycles 1002(A) and 1002(B). For example, the first compression-decompression cycle 1002(A) may be associated with a 40:60 duty cycle (e.g., 40% of the time in compression phase 1004 and 60% of the time in decompression phase 1006), and the second compression-decompression cycle 1002(B) may be associated with a 50:50 duty cycle (e.g., 50% of the time in compression phase 1004 and 50% of the time in decompression phase 1006). Accordingly, blood flow through the aortic valve can be detected in a heart sound signal (e.g., the heart sound signals exhibited in the first audio signal 1700 during the first hold periods 1706(1)(A) and 1706(1)(B)). Furthermore, when such a heart sound signal disappears or is otherwise absent during the compression phase 1004 (e.g., the highlighted area indicating absence of blood flow sound 1704), the processor(s) 1614 of the mechanical chest compression device 102 may detect closure of the aortic valve. This can be used to determine if the correct compression position is being used, for example, by applying a 50:50 duty cycle, and then monitoring the heart sound signal exhibited in the first audio signal 1700 to determine whether the heart sound signal disappears (e.g., by detecting an absence of blood flow sound 1704 at the end of the compression phase 1004). If the heart sound signal disappears at the end of the compression phase 1004, the compression position may be correct, and if the heart sound signal does not disappear at the end of the compression phase 1004, the compression position is incorrect. Further, if an absence of blood flow sound 1704 at the end of the compression phase 1004 is longer than a threshold duration, this may indicate that an aspect of the CPR being administered should be adjusted, such the duty cycle of chest compressions (e.g., decreasing the duty cycle from a 50:50 duty cycle to a 40:60 duty cycle may improve the quality of CPR.

More generally, the example of FIG. 17 demonstrates that turbulent blood flow creates a detectable heart sound that may be recorded using an auscultation device(s), such as the auscultation device(s) 302 or the auscultation device 402. The detection of the presence or absence of this blood flow sound signal may be used in order to detect if the aortic valve is open or closed. The heart sound signal may be analyzed during the compression phase 1004 in order to detect the presence of blood flow through the aortic valve. The time point of the aortic valve closure may be determined by the time point when sound from blood flow disappears, since, when the aortic valve closes, no blood will flow through the aortic valve anymore. When the mechanical chest compression device 102 is being used to administer CPR to the subject 104, this heart sound signal can be used to determine the optimal compression position and/or to determine whether the current compression position is incorrect and to automatically control and adjust the compression position of the mechanical chest compression device 102 during ongoing CPR (e.g., by performing the process 900 of FIG. 9, the process 1100 of FIG. 11, and/or the process 1200 of FIG. 12). When a CPR feedback system 202 is being used to provide guidance to a rescuer 204 who is manually administering CPR to the subject 104, this heart sound signal can be used to determine the optimal compression position and/or to determine whether the current compression position is incorrect and to output a signal (e.g., the visual CPR feedback signal(s) 222, audible CPR feedback signal(s) 220, and/or haptic CPR feedback signal(s) 224) as guidance for the rescuer 204 to adjust the compression position, as described in detail above (e.g., by performing the process 900 of FIG. 9, the process 1100 of FIG. 11, and/or the process 1200 of FIG. 12).

In some examples, the heart sound signal(s) (e.g., blood flow sounds) illustrated in FIG. 17 can be used to determine the quality of CPR being performed (e.g., whether high quality CPR is being performed or not). For example, the heart sound signal exhibited in the first audio signal 1700 not only shows when blood flow is present and created, but also how much blood flow is being created since the energy in the heart sound signal provides an estimate of the blood flow created (e.g., the stroke volume and the cardiac output). An estimation of the created blood flow is also an estimation of the quality of CPR. The higher the created blood flow (e.g., energy in the heart sound signal), the better the performance of CPR. The quality of CPR may be obtained from different measures related to the energy of the heart sound signal in the first audio signal 1700 including, without limitation, the maximum and/or mean and/or median of the amplitude, magnitude, root-mean-square (RMS), standard deviation, variance, or entropy. These different measures may be obtained in a defined time segment of the heart sound signal exhibited in the first audio signal 1700 and/or during the entire segment with “detected blood flow” (e.g., during the compression phase 1004 until the time point of aortic valve closure).

Although there are advantages of using multiple audio capture devices (e.g., using the auscultation device(s) 302 in conjunction with the microphone 308(1), or using the auscultation device 402 in conjunction with the microphone 406), such as identifying and filtering out the sounds of the mechanical chest compression device 102 (e.g., chest compression artifacts) from the first audio signal 1700, improving the SNR, and/or the like, it is to be appreciated that a single auscultation device can be used for determining the optimal/preferred compression position and for dynamically adjusting the compression position and/or outputting feedback or guidance to a rescuer to adjust the compression position. For example, the mechanical chest compression device 102 may include and/or utilize the auscultation device 302(1) by itself to generate the first audio signal 1700 depicted in FIG. 17, and the processor(s) 1614 may analyze the first audio signal 1700 to determine if there is an absence of blood flow sound during the compression phase 1004 of a compression-decompression cycle 1002, and, if not, adjust the compression position. As another example, the CPR feedback device 206 may include and/or utilize the auscultation device 402 by itself to generate an audio signal similar to the first audio signal 1700 depicted in FIG. 17, and the processor(s) of the CPR feedback system 202 may analyze the audio signal to determine if there is an absence of blood flow sound during the compression phase 1004 of a compression-decompression cycle 1002, and, if not, output a signal(s) as guidance for the rescuer 204 to adjust the compression position. In some examples, if an absence of blood flow sound occurs at the end of the compression phase 1004 of a compression-decompression cycle 1002, a CPR duty cycle guidance system may output a signal(s) as feedback or guidance for the rescuer 204 (e.g., indicating that they are administering chest compressions at the correct compression position). In some examples, an iterative optimization algorithm is utilized to determine, based on the presence of blood flow sound during the entirety of the compression phase 1004, whether the compression position should be changed. That is, the presence of blood flow sound throughout the entirety of the compression phase 1004 may indicate the compression position should be changed, and the system may adjust or output a signal(s) for the rescuer 204 to adjust the compression position until absence of blood flow sound is detected in the audio signal (e.g., the first audio signal 1700) during the compression phase 1004, and then converge on the optimal compression position after this absence of blood flow sound is detected.

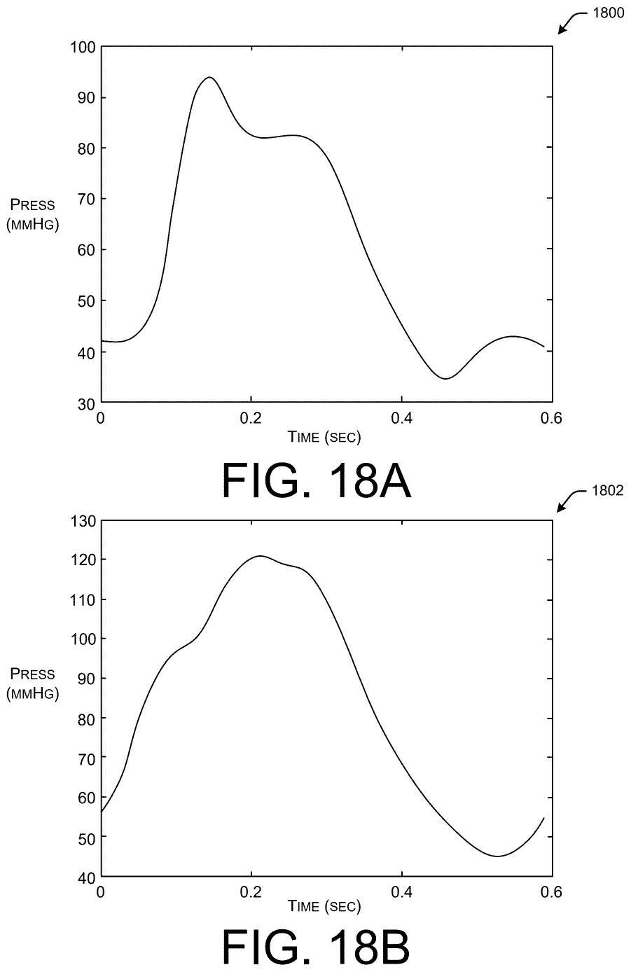

FIGS. 18A and 18B illustrate arterial blood pressure curves associated with respective cardiac arrest patients during administration of CPR to the patients. The general conception is that pressure creates blood flow. However, this general conception is incorrect. It is how the pressure is created that determines if desired blood flow is obtained or not. Different compression positions create different pressure profiles (e.g., waveforms/shapes). That is, pressure is created differently with different compressions positions, and, thus, blood flow is different with different compression positions. Pressure profiles/curves with a dicrotic notch create more forward flow compared to pressure profiles/curves without a dicrotic notch (since the dicrotic notch is an indicator of aortic valve closure). Not only is the presence of a dicrotic notch in the pressure curve important, but the timing of the dicrotic notch (i.e., at what time point within the pressure curve the dicrotic notch is present) is also important. In other words, it is not the absolute blood pressure value that is the best marker for high quality CPR, it is the shape of the blood pressure curve.

This contradicts the general conception, since high blood pressure values during CPR are generally perceived as better than low blood pressure values. For patients with an arterial line in place, targeting CPR to a particular blood pressure has been suggested in order to improve outcomes. Literature and publications have, for instance, suggested targeting a blood pressure value greater than a mean arterial blood pressure (MAP) of 70 mmHg, since this value has been suggested to provided good perfusion to organs. Other suggestions have been to target a blood pressure value greater than a MAP of 65 mmHg, since a blood pressure value lower than 65 mmHg is often used to define hypotension (a too low blood pressure).

In FIG. 18A, an arterial blood pressure curve 1800 associated with a cardiac arrest patient during ongoing CPR at a rate of 100 compressions per minute is illustrated, wherein the Y-axis is pressure in mmHg, and the X-axis is time in seconds. FIG. 18A illustrates the arterial blood pressure curve 1800 during one compression-decompression cycle 1002, where the absolute blood pressure values are 95 mmHg in systolic blood pressure, 40 mmHg in diastolic blood pressure, and a MAP of about 58 mmHg. Note that the MAP for the patient associated with the arterial blood pressure curve 1800 is lower than both the suggested target values above (70 mmHg and 65 mmHg), and thus, the general conception would be that high quality CPR is not provided to the patient associated with the arterial blood pressure curve 1800. Furthermore, note that a dicrotic notch is clearly visible (around the 0.2 second mark) in the arterial blood pressure curve 1800 of FIG. 18A. In addition, the cardiac arrest patient associated with the arterial blood pressure curve 1800 of FIG. 18A obtained ROSC. Thus, the patient associated with the arterial blood pressure curve 1800 of FIG. 18A had a good clinical outcome despite low blood pressure values due to a “good” blood pressure waveform/shape.

In FIG. 18B, an arterial blood pressure curve 1802 associated with a cardiac arrest patient during ongoing CPR at a rate of 100 compressions per minute is illustrated, wherein the Y-axis is pressure in mmHg, and the X-axis is time in seconds. FIG. 18B illustrates the arterial blood pressure curve 1802 during one compression-decompression cycle 1002, where the absolute blood pressure values are 120 mmHg in systolic blood pressure, 50 mmHg in diastolic blood pressure, and a MAP of about 73 mmHg. Note that the MAP for the patient associated with the arterial blood pressure curve 1802 is higher than both the suggested target values above (70 mmHg and 65 mmHg), and thus, the general conception would be that high quality CPR is provided to the patient associated with the arterial blood pressure curve 1802. Furthermore, note that a dicrotic notch is not present in the arterial blood pressure curve 1802 of FIG. 18B. In addition, the cardiac arrest patient associated with the arterial blood pressure curve 1802 of FIG. 18B did not obtain ROSC. Thus, the patient associated with the arterial blood pressure curve 1802 of FIG. 18B had a bad clinical outcome despite high blood pressure values due to a “bad” blood pressure waveform/shape.

The results in FIGS. 18A and 18B, which were obtained from real clinical data, demonstrate that it is the shape of the blood pressure waveform (e.g., curves 1800 and 1802) and not the absolute blood pressure value that determines the performance of CPR and the clinical outcome. Note that the cardiac arrest patient associated with the arterial blood pressure curve 1802 of FIG. 18B not only had a higher MAP, but also had higher systolic and diastolic blood pressure values, compared to the cardiac arrest patient associated with the arterial blood pressure curve 1800 of FIG. 18A. A patient associated with an arterial blood pressure curve that includes a dicrotic notch at the right time point (e.g., the arterial blood pressure curve 1800 of FIG. 18A) has a higher likelihood of obtaining ROSC compared to a patient with no dicrotic notch present (or non-desirable dicrotic notch present at the incorrect time point).

In an example, blood pressure curves may be obtained using a defibrillator 208, 1500 (e.g., a monitor-defibrillator, AED, etc.) during administration of ongoing CPR to a cardiac arrest subject 104. Based on the shape of the blood pressure curve (e.g. based on dicrotic notch features exhibited in the blood pressure curve), the subject 104 may be classified as being associated with high quality CPR or not. The classification can determine and predict the clinical outcome of the subject 104, since this classification should represent either a group with high quality CPR or a group with low quality CPR. Thus, the classification may be used as a predictor of ROSC for the subject 104, e.g., this classification may provide a likelihood of the subject 104 receiving ROSC or not.

In another example, an audio sound signal may be obtained using a defibrillator 208, 1500 (e.g., monitor-defibrillator, AED, etc.) and/or a mechanical chest compression device 102, 1600, with a connected auscultation device (e.g., microphone), during administration of CPR to a cardiac arrest subject 104. Based on the audio signal (e.g. based on dicrotic notch features exhibited in the audio signal, such as detection of the presence of a dicrotic notch and/or the time point of the presence of a dicrotic notch, which may be indicated by the absence of blood flow sound 1704 in an audio signal, such as the first audio signal 1700), the subject 104 may be classified as being associated with high quality CPR or not. The classification can determine and predict the clinical outcome of the subject 104, since this classification should represent either a group with high quality CPR or a group with low quality CPR. Thus, the classification may be used as a predictor of ROSC for the subject 104, e.g., this classification may provide a likelihood of the subject 104 receiving ROSC or not.

Note that a monitor and/or defibrillator (e.g., AED) may be used to determine if high quality CPR is being provided and/or if the compression point is correct, and/or determine the likelihood of obtaining ROSC (i.e. a ROSC predictor). This may be obtained by connecting a blood pressure sensor and/or a microphone to the monitor and/or defibrillator (e.g., AED) to obtain a blood pressure signal and/or an audio signal, respectively.

### Example Clauses

1. A cardiopulmonary resuscitation (CPR) system for use in CPR treatment of a subject, the CPR system comprising: a sensor configured to sense a parameter associated with the subject as chest compressions are being administered to the subject; and a processor configured to:
determine, by analyzing the parameter sensed by the sensor, that an aortic valve or a pulmonary valve of a heart of the subject closed incompletely during a compression phase of a compression-decompression cycle; and in response to determining that the aortic valve or the pulmonary valve closed incompletely, cause a feedback signal to be output as feedback instructing a rescuer to change a position on a chest of the subject at which future chest compressions are to be administered to the subject.
2. The CPR system of clause 1, wherein the parameter comprises: a blood pressure parameter; a blood flow parameter; an ultrasound parameter; a photoplethysmography (PPG) parameter; or an audible heart sound parameter.
3. The CPR system of clause 1, wherein the sensor is an auscultation device configured to be disposed on the chest or a back of the subject.
4. The CPR system of clause 3, wherein: the auscultation device and the processor are integrated into a mechanical chest compression device, the mechanical chest compression device comprising a chest compressing mechanism configured to be placed on the chest of the subject and to administer the chest compressions to the subject by: repeatedly applying a force to the chest of the subject; and releasing the force in between successive applications of the force; and the feedback instructs the rescuer to change the position on the chest of the subject at which of the chest compressing mechanism is disposed.
5. The CPR system of clause 4, wherein: the chest compressing mechanism comprises a piston; the mechanical chest compression device further comprises a backplate configured to be disposed under the back of the subject; and the auscultation device is disposed on: a distal end of the piston that is configured to contact the chest of the subject; or an inner surface of the backplate that is configured to contact the back of the subject.
6. The CPR system of any one of clauses 3 to 5, wherein: the auscultation device is integrated into a CPR feedback device that is configured to be disposed on the chest of the subject; and the feedback instructs the rescuer to change the position on the chest of the subject at which hands of the rescuer are placed for manually administering the chest compressions.
7. The CPR system of any one of clauses 1 to 6, wherein the processor is further configured to: determine that a compression depth parameter associated with the chest compressions is within a first target value range; and determine that a compression rate parameter associated with the chest compressions is within a second target value range, wherein causing the feedback signal to be output is further in response to determining that the compression depth parameter is within the first target value range and that the compression rate parameter is within the second target value range.
8. A cardiopulmonary resuscitation (CPR) system comprising: a sensor configured to sense a parameter associated with a subject as chest compressions are being administered to the subject; and a processor configured to: determine, by analyzing the parameter sensed by the sensor, that a heart valve of the subject is not functioning; and in response to determining that the heart valve of the subject is not functioning, cause a feedback signal to be output as feedback to change a position on a chest of the subject at which future chest compressions are to be administered to the subject.
9. The CPR system of clause 8, wherein the parameter comprises: a blood pressure parameter; a blood flow parameter; an ultrasound parameter; a photoplethysmography (PPG) parameter; or an audible heart sound parameter.
10. The CPR system of clause 8, wherein the sensor is an auscultation device configured to be disposed a thorax of the subject.
11. The CPR system of clause 10, wherein: the auscultation device and the processor are components of a mechanical chest compression device, the mechanical chest compression device comprising a chest compressing mechanism configured to be disposed on the chest and to administer the chest compressions to the subject; and the feedback instructs a rescuer to change the position on the chest at which of the chest compressing mechanism is disposed.
12. The CPR system of clause 11, wherein: the chest compressing mechanism comprises a piston; the mechanical chest compression device further comprises a backplate configured to be disposed under a back of the subject; and the auscultation device is disposed on: a distal end of the piston that is configured to contact the chest; or an inner surface of the backplate that is configured to contact the back.
13. The CPR system of clause 11 or 12, wherein: the processor is further configured to cause, during a compression phase of a compression-decompression cycle, the chest compressing mechanism to move from a first position to a second position that represents a target compression depth; and cause the auscultation device to detect a heart sound in response to the chest compressing mechanism arriving at the second position.
14. The CPR system of clause 10, wherein: the auscultation device is a component of a CPR feedback device that is configured to be disposed on the chest; and the feedback instructs a rescuer to change the position on the chest at which hands of the rescuer are placed for manually administering the chest compressions.
15. The CPR system of clause 14, wherein the auscultation device is disposed on an inner surface of the CPR feedback device that is configured to contact the chest.
16. The CPR system of any one of clauses 8 to 15, wherein the feedback signal is output as an audible signal, a visual signal, or a haptic signal.
17. The CPR system of any one of clauses 10 to 16, wherein: the CPR system further comprises a microphone configured to detect a sound in an environment where the CPR system is located while the chest compressions are being administered to the subject; and the processor is further configured to perform active-noise-cancellation (ANC) to remove the sound in the environment detected by the auscultation device.
18. The CPR system of any one of clauses 10 to 17, wherein the auscultation device comprises an array of microphones configured to be disposed on the thorax and to detect an audible heart sound associated with the subject.
19. The CPR system of any one of clauses 8 to 18, wherein: the parameter is analyzed at a first time to determine that the heart valve of the subject is not functioning; the feedback signal is a first feedback signal; and the processor is further configured to: determine, by analyzing the parameter sensed by the sensor at a second time after the first time, that the heart valve of the subject is functioning; and in response to determining that the heart valve of the subject is functioning, cause a second feedback signal to be output as feedback indicating that the position on the chest at which the chest compressions are being administered to the subject is a correct position.
20. The CPR system of any one of clauses 8 to 19, wherein determining that the heart valve of the subject is not functioning comprises determining that an aortic valve or a pulmonary valve of a heart of the subject closed incompletely during a compression phase of a compression-decompression cycle.
21. The CPR system of any one of clauses 8 to 20, wherein the processor is further configured to: determine that a compression depth parameter associated with the chest compressions is within a first target value range; and determine that a compression rate parameter associated with the chest compressions is within a second target value range, wherein causing the feedback signal to be output is further in response to determining that the compression depth parameter is within the first target value range and that the compression rate parameter is within the second target value range.
22. A method comprising: receiving, by a processor of a cardiopulmonary resuscitation (CPR) system, a parameter associated with a subject and sensed by sensor of the CPR system during administration of chest compressions to the subject; determining, by the processor, and by analyzing the parameter sensed by the sensor, that a heart valve of the subject is not functioning; and in response to determining that the heart valve of the subject is not functioning, causing, by the processor, a feedback signal to be output as feedback to change a position on a chest of the subject at which future chest compressions are to be administered to the subject.
23. The method of clause 22, wherein the parameter comprises: a blood pressure parameter;
a blood flow parameter; an ultrasound parameter; a photoplethysmography (PPG) parameter; or an audible heart sound parameter.
24. The method of clause 22, wherein the sensor is an auscultation device configured to be disposed on a thorax of the subject.
25. The method of clause 24, wherein the auscultation device and the processor are components of a mechanical chest compression device, the method further comprising: causing, by the processor, during a compression phase of a compression-decompression cycle, a chest compressing mechanism of the mechanical chest compression device to move from a first position to a second position that represents a target compression depth; and causing, by the processor, the auscultation device to detect a heart sound in response to the chest compressing mechanism arriving at the second position.
26. The method of clause 24, wherein the auscultation device and the processor are components of a mechanical chest compression device, the method further comprising: causing, by the processor, a chest compressing mechanism of the mechanical chest compression device to move during a compression phase of a compression-decompression cycle; and causing, by the processor, the auscultation device to detect a heart sound in response to determining an expiration of a predetermined amount of time since a start of the compression phase.
27. The method of any one of clauses 24 to 26, further comprising: receiving, by the processor, from a microphone, an audio signal representing a sound in an environment where the CPR system is located while the chest compressions are being administered to the subject; and performing, by the processor, active-noise-cancellation (ANC) to remove the sound in the environment detected by the auscultation device.
28. The method of any one of clauses 22 to 27, wherein: the parameter is analyzed at a first time to determine that the heart valve of the subject is not functioning; the feedback signal is a first feedback signal; and the method further comprises: determining, by the processor, and by analyzing the parameter sensed by the sensor at a second time after the first time, that the heart valve of the subject is functioning; and in response to determining that the heart valve of the subject is functioning, causing, by the processor, a second feedback signal to be output as feedback indicating that the position on the chest at which the chest compressions are being administered to the subject is a correct position.
29. The method of any one of clauses 22 to 28, further comprising: determining, by the processor, that a compression depth parameter associated with the chest compressions is within a first target value range; and determining, by the processor, that a compression rate parameter associated with the chest compressions is within a second target value range, wherein causing the feedback signal to be output is further in response to determining that the compression depth parameter is within the first target value range and that the compression rate parameter is within the second target value range.
30. A mechanical chest compression device comprising: a chest compressing mechanism configured to be disposed on a chest of a subject and to administer chest compressions to the subject; a sensor configured to sense a parameter associated with the subject as the chest compressions are being administered to the subject; and a processor configured to: cause the chest compressing mechanism to move for administering the chest compressions to the subject; determine, by analyzing the parameter sensed by the sensor, that a heart valve of the subject is not functioning; and in response to determining that the heart valve of the subject is not functioning, cause the chest compressing mechanism to change a position on the chest of the subject at which future chest compressions are to be administered to the subject.
31. A cardiopulmonary resuscitation (CPR) system for use in CPR treatment of a subject, the CPR system comprising: a measuring device configured to be disposed on the subject and to detect a heart valve parameter as chest compressions are being administered to the subject; and a processor configured to: receive the heart valve parameter from the measuring device; determine, by analyzing the heart valve parameter, that the heart valve parameter lacks a feature indicative of an aortic valve or a pulmonary valve of a heart of the subject closing completely during a compression phase of a compression-decompression cycle; and in response to determining that the heart valve parameter lacks the feature, cause a feedback signal to be output as feedback instructing a rescuer to change a position on a chest of the subject at which future chest compressions are to be administered to the subject.
32. The CPR system of clause 31, wherein the measuring device is a microphone.
33. The CPR system of clause 31, wherein the measuring device is configured to obtain a pulse wave signal from a blood pressure recording, a photoplethysmography (PPG) recording, or an ultrasound recording.
34. The CPR system of clause 31 or 32, wherein the heart valve parameter is an audio signal.
35. The CPR system of clause 31 or 33, wherein the heart valve parameter is a dicrotic notch in a pulse wave signal.
36. A mechanical chest compression device comprising: a chest compressing mechanism configured to be disposed on a chest of a subject and to administer chest compressions to the subject; a motor configured to cause the chest compressing mechanism to move to administer the chest compressions to the subject; an auscultation device configured to be disposed on a thorax of the subject and to detect a heart sound associated with the subject as the chest compressions are being administered to the subject; and a processor configured to: receive a compression signal indicative of at least one of a position of the chest compressing mechanism, a compression depth associated with the chest compressions, an acceleration associated with the chest compressions, an electrical current associated with the motor, or a rotation parameter associated with the motor; determine, by analyzing the compression signal, that a criterion is satisfied; in response to determining that the criterion is satisfied, cause the auscultation device to detect the heart sound; determine, by analyzing the heart sound, that a heart valve of the subject is not functioning; and in response to determining that the heart valve of the subject is not functioning, cause a feedback signal to be output as feedback to change a position on the chest at which the chest compressing mechanism is disposed.
37. A mechanical chest compression device comprising: a chest compressing mechanism configured to be disposed on a chest of a subject and to administer chest compressions to the subject; a motor configured to cause the chest compressing mechanism to move to administer the chest compressions to the subject; an auscultation device configured to be disposed a thorax of the subject and to detect a heart sound associated with the subject as the chest compressions are being administered to the subject; and a processor configured to: receive an audio signal representing the heart sound detected by the auscultation device; receive a compression signal indicative of at least one of a position of the chest compressing mechanism, a compression depth associated with the chest compressions, an acceleration associated with the chest compressions, an electrical current associated with the motor, or a rotation parameter associated with the motor; remove, from the audio signal, and based on the compression signal, a sound representing movement of the chest compressing mechanism or operation of the motor of to obtain a filtered audio signal; determine, by analyzing the filtered audio signal, that a heart valve of the subject is not functioning; and in response to determining that the heart valve of the subject is not functioning, cause a feedback signal to be output as feedback to change a position on the chest at which of the chest compressing mechanism is disposed.
38. A cardiopulmonary resuscitation (CPR) system comprising: a sensor configured to sense a parameter associated with a subject as chest compressions are being administered to the subject; and a processor configured to: determine, by analyzing the parameter sensed by the sensor, whether a heart valve of the subject is functioning; and in response to determining whether the heart valve of the subject is functioning, cause a feedback signal to be output as feedback indicating a likelihood of return of spontaneous circulation (ROSC) in association with the subject.
39. A mechanical chest compression device for use in cardiopulmonary resuscitation (CPR) treatment of a subject, the mechanical chest compression device comprising: a piston configured to be placed on a chest of the subject and to administer chest compressions to the subject by: extending and applying a downward force to the chest of the subject; and retracting and releasing the downward force in between successive applications of the downward force; a backplate configured to be disposed under a back of the subject; and a microphone disposed on: a distal end of the piston that is configured to contact the chest of the subject; or an inner surface of the backplate that is configured to contact the back of the subject.
40. The mechanical chest compression device of clause 39, wherein the microphone is configured to detect an audible heart sound associated with the subject as the chest compressions are being administered to the subject.
41. The mechanical chest compression device of clause 39, further comprising: a main portion comprising the piston; a pair of legs extending from the main portion, each leg of the pair of legs configured to connect to a respective side of the backplate, wherein the microphone is configured to detect an audible connection sound indicating that the pair of legs have been connected to the backplate; and a processor configured to enable operation of the mechanical chest compression device in response to the microphone detecting the audible connection sound.
42. The mechanical chest compression device of clause 40, wherein: the microphone is a first microphone; and the mechanical chest compression device further comprises: a second microphone disposed on an external surface of the mechanical chest compression device and configured to detect a sound in an environment where the mechanical chest compression device is located while the chest compressions are being administered to the subject; and a processor configured to perform active-noise-cancellation (ANC) to remove the sound in the environment detected by the first microphone.
43. A mechanical chest compression device comprising: a piston configured to be disposed on a chest of a subject and to administer chest compressions to the subject; a backplate configured to be disposed under a back of the subject; and a microphone disposed on: a distal end of the piston that is configured to contact the chest; or an inner surface of the backplate that is configured to contact the back.
44. The mechanical chest compression device of clause 43, wherein the microphone is configured to detect an audible heart sound associated with the subject as the chest compressions are being administered to the subject.
45. The mechanical chest compression device of clause 43, further comprising: a main portion comprising the piston; a pair of legs extending from the main portion, each leg of the pair of legs configured to connect to a respective side of the backplate, wherein the microphone is configured to detect an audible connection sound indicating that the pair of legs have been connected to the backplate; and a processor configured to enable operation of the mechanical chest compression device in response to the microphone detecting the audible connection sound.
46. The mechanical chest compression device of clause 43 or 44, wherein the microphone is a first microphone, the mechanical chest compression device further comprising a second microphone disposed on an external surface of the mechanical chest compression device.
47. The mechanical chest compression device of clause 46, wherein: the second microphone is configured to detect a sound in an environment where the mechanical chest compression device is located while the chest compressions are being administered to the subject; and the mechanical chest compression device further comprises a processor configured to perform active-noise-cancellation (ANC) to remove the sound in the environment detected by the first microphone.
48. The mechanical chest compression device of clause 46 or 47, wherein the second microphone is configured to record a monologue of a rescuer or a dialogue between multiple rescuers as the chest compressions are being administered to the subject.
49. The mechanical chest compression device of any one of clauses 43, 46, 47, or 48, wherein: the microphone is configured to detect an audible heart sound associated with the subject as the chest compressions are being administered to the subject; and the mechanical chest compression device further comprises a processor configured to: determine, by analyzing an audio signal received from the microphone, that an aortic valve or a pulmonary valve of a heart of the subject closed incompletely during a compression phase of a compression-decompression cycle; and in response to determining that the aortic valve or the pulmonary valve closed incompletely, cause a feedback signal to be output as feedback to change a position on the chest at which the piston is disposed.
50. The mechanical chest compression device of clause 49, further comprising a light emitting diode (LED) disposed on an external surface of the mechanical chest compression device, wherein causing the feedback signal to be output comprises causing the LED to emit light of a particular color.
51. The mechanical chest compression device of any one of clauses 43, 46, 47, or 48, wherein: the microphone is configured to detect an audible heart sound associated with the subject as the chest compressions are being administered to the subject; and the mechanical chest compression device further comprises a processor configured to: determine, by analyzing an audio signal received from the microphone, that an aortic valve or a pulmonary valve of a heart of the subject closed completely during a compression phase of a compression-decompression cycle; and in response to determining that the aortic valve or the pulmonary valve closed completely, cause a feedback signal to be output as feedback indicating that a position on the chest at which the chest compressions are being administered to the subject is a correct position.
52. A cardiopulmonary resuscitation (CPR) feedback device configured to be disposed on a chest of a subject, the CPR feedback device comprising: an accelerometer configured to detect a chest compression parameter associated with chest compressions that a rescuer is manually administering to the subject; and a microphone configured to detect sound during administration of the chest compressions.
53. The CPR feedback device of clause 52, wherein the microphone is: disposed on an inner surface of the CPR feedback device that is configured to contact the chest; and configured to detect an audible heart sound associated with the subject as the chest compressions are being administered to the subject.
54. The CPR feedback device of clause 53, wherein the microphone is a first microphone, the CPR feedback device further comprising a second microphone disposed on an outer surface of the CPR feedback device.
55. The CPR feedback device of clause 54, wherein the second microphone is configured to record a monologue of the rescuer or a dialogue between the rescuer and another rescuer as the chest compressions are being administered to the subject.
56. The CPR feedback device of clause 52, wherein the microphone is disposed on an outer surface of the CPR feedback device and configured to record a monologue of the rescuer or a dialogue between the rescuer and another rescuer as the chest compressions are being administered to the subject.
57. The CPR feedback device of any one of clauses 52 to 56, wherein the microphone is one microphone of an array of microphones.
58. A cardiopulmonary resuscitation (CPR) feedback system comprising: a CPR feedback device configured to be disposed on a chest of a subject, the CPR feedback device comprising: a first microphone disposed on an inner surface of the CPR feedback device that is configured to contact the chest, wherein the first microphone is configured to detect an audible heart sound associated with the subject as a rescuer is manually administering chest compressions to the subject; and a second microphone disposed on an outer surface of the CPR feedback device and configured to detect a sound in an environment where the CPR feedback system is located while the chest compressions are being administered to the subject; and a monitor-defibrillator communicatively coupled with the CPR feedback device, wherein a processor of the monitor-defibrillator is configured to perform active-noise-cancellation (ANC) to remove the sound in the environment detected by the first microphone.
59. A cardiopulmonary (CPR) system for use in CPR treatment of a subject, the CPR system including: a sensor configured to detect an audible heart sound parameter of the subject during administration of chest compressions to the subject; and a processor configured to: determine, by analyzing the audible heart sound parameter, an audio signature indicative of heart valve function of the subject; determine, by analyzing the audio signature, a likelihood of return of spontaneous circulation (ROSC) in association with the subject; and in response to determining the likelihood of ROSC, cause an output device to output an instruction to cease the administration of the chest compressions to the subject.
60. The CPR system of clause 59, wherein the processor is configured to determine the audio signature indicative of heart valve function of the subject by: identifying, by analyzing the audible heart sound parameter a blood flow parameter of the subject, the blood flow parameter being indicative of blood flow of the subject occurring independently of the chest compressions administered to the subject.
61. The CPR system of clause 59 or 60, wherein the processor is further configured to: identify administration of an electrical shock to the subject, wherein the audio signature is determined in response to identifying the administration of the electrical shock.
62. A medical device including: a sensor configured to detect an audible heart sound parameter of a subject; and a processor configured to: determine, by analyzing the audible heart sound parameter, a likelihood of return of spontaneous circulation (ROSC) in association with the subject; and in response to determining the likelihood of ROSC, cause an output device to output an instruction indicative of a treatment parameter to administer to the subject.
63. The medical device of clause 62, wherein the sensor includes a microphone or a piezoelectric transducer.
64. The medical device of clause 62 or 63, wherein the sensor is an auscultation device configured to be disposed on a chest or a back of the subject.
65. The medical device of any one of clauses 62 to 64, wherein the processor is configured to determine the likelihood of ROSC in association with the subject by: identifying, by analyzing the audible heart sound parameter, an audio signature that is indicative of a pulse rate of the subject that is asynchronous from a frequency of chest compressions administered to the subject.
66. The medical device of any one of clauses 62 to 65, wherein the processor is configured to determine the likelihood of ROSC in association with the subject by: identifying first data indicative of the audible heart sound parameter collected during a first time duration; identifying second data indicative of the audible heart sound parameter collected during a second time duration, the first time duration occurring prior to the second time duration; and identifying a difference between the first data and the second data to identify the likelihood of ROSC during the second time duration.
67. The medical device of clause 66, wherein chest compressions are administered to the subject during the first time duration and the second time duration.
68. The medical device of clause 66 or 67, wherein administration of chest compressions to the subject is paused during the first time duration and the second time duration.
69. The medical device of any one of clauses 62 to 68, wherein the treatment parameter includes a position on a chest of the subject at which to administer chest compressions to the subject, a frequency at which to administer chest compressions to the subject, or a depth of chest compressions to administer to the subject.
70. The medical device of any one of clauses 62 to 69, wherein the processor is further configured to: identify administration of an electrical shock to the subject, wherein the likelihood of ROSC in association with the subject is determined in response to identifying the administration of the electrical shock.
71. A method performed by a medical device, the method including: identifying data indicative of an audible heart sound parameter of a subject; identifying, by analyzing the audible heart sound parameter, an audio signature indicative of heart valve function of the subject; determining, by analyzing the audio signature, a likelihood of return of spontaneous circulation (ROSC) in association with the subject; and in response to determining the likelihood of ROSC, causing an output device to output an instruction indicative of a treatment parameter to administer to the subject.
72. The method of clause 71, wherein identifying the audio signature indicative of heart valve function of the subject includes: identifying first data indicative of the audible heart sound parameter collected during a first time duration; identifying second data indicative of the audible heart sound parameter collected during a second time duration, the first time duration occurring prior to the second time duration; and
comparing the first data to the second data to identify the audio signature in the second data, the audio signature being indicative of a difference between the first data and the second data.
73. The method of clause 72, wherein a treatment is administered to the subject during the first time duration and the second time duration.
74. The method of clause 72 or 73, wherein administration of a treatment to the subject is paused during the first time duration and the second time duration.
75. The method of any one of clauses 72 to 74, wherein comparing the first data to the second data to identify the audio signature in the second data includes: determining a change in blood flow of the subject between the first time duration and the second time duration.
76. The method of any one of clauses 71 to 75, wherein identifying the audio signature indicative of heart valve function of the subject includes: identifying, by analyzing the audible heart sound parameter, a blood flow parameter of the subject, the blood flow parameter being indicative of blood flow occurring independently of chest compressions administered to the subject.
77. The method of any one of clauses 71 to 76, wherein determining the likelihood of ROSC in association with the subject includes: determining, by analyzing the audio signature, whether an aortic valve or a pulmonary valve of a heart of the subject closed incompletely during a compression phase of a compression-decompression cycle.
78. The method of any one of clauses 71 to 77, further including: identifying, by analyzing the audible heart sound parameter, damage to a thorax of the subject, wherein the instruction instructs a rescuer to cease administration of chest compressions to the subject.

While the example clauses described above are described with respect to one particular implementation, it should be understood that, in the context of this document, the content of the example clauses can also be implemented via a method, device, system, computer-readable medium, and/or another implementation. Additionally, any one of examples 1-78 may be implemented alone or in combination with any other of the examples 1-78.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain implementations are described herein, including the best mode known to the inventors for carrying out implementations of the disclosure. Of course, variations on these described implementations will become apparent to those of ordinary skill in the art upon reading the foregoing description. The inventors expect skilled artisans to employ such variations as appropriate, and the inventors intend for implementations to be practiced otherwise than specifically described herein. Accordingly, the scope of this disclosure includes all modifications and equivalents of the subject matter recited in the claims appended hereto as permitted by applicable law. Moreover, any combination of the above-described elements in all possible variations thereof is encompassed by implementations of the disclosure unless otherwise indicated herein or otherwise clearly contradicted by context.

What is claimed is:

1. A cardiopulmonary resuscitation (CPR) system for use in CPR treatment of a subject, the CPR system comprising:
a sensor configured to sense a parameter associated with the subject as chest compressions are being administered to the subject; and
a processor configured to:
determine, by analyzing the parameter sensed by the sensor, that an aortic valve or a pulmonary valve of a heart of the subject closed incompletely during a compression phase of a compression-decompression cycle; and
in response to determining that the aortic valve or the pulmonary valve closed incompletely, cause a feedback signal to be output as feedback instructing a rescuer to change a position on a chest of the subject at which future chest compressions are to be administered to the subject.

2. The CPR system of claim 1, wherein the parameter comprises:
a blood pressure parameter;
a blood flow parameter;
an ultrasound parameter;
a photoplethysmography (PPG) parameter; or
an audible heart sound parameter.

3. The CPR system of claim 1, wherein the sensor is an auscultation device configured to be disposed on the chest or a back of the subject.

4. The CPR system of claim 3, wherein:
the auscultation device and the processor are integrated into a mechanical chest compression device, the mechanical chest compression device comprising a chest compressing mechanism configured to be placed on the chest of the subject and to administer the chest compressions to the subject by:
repeatedly applying a force to the chest of the subject ; and
releasing the force in between successive applications of the force; and
the feedback instructs the rescuer to change the position on the chest of the subject at which of the chest compressing mechanism is disposed.

5. The CPR system of claim 3, wherein:
the auscultation device is integrated into a CPR feedback device that is configured to be disposed on the chest of the subject; and
the feedback instructs the rescuer to change the position on the chest of the subject at which hands of the rescuer are placed for manually administering the chest compressions.

6. A cardiopulmonary resuscitation (CPR) system comprising:
a sensor configured to sense a parameter associated with a subject as chest compressions are being administered to the subject; and
a processor configured to:
determine, by analyzing the parameter sensed by the sensor, that a heart valve of the subject is not functioning; and
in response to determining that the heart valve of the subject is not functioning, cause a feedback signal to be output as feedback to change a position on a chest of the subject at which future chest compressions are to be administered to the subject.

7. The CPR system of claim 6, wherein the parameter comprises:
a blood pressure parameter;
a blood flow parameter;
an ultrasound parameter;
a photoplethysmography (PPG) parameter; or
an audible heart sound parameter.

8. The CPR system of claim 6, wherein the sensor is an auscultation device configured to be disposed a thorax of the subject.

9. The CPR system of claim 8, wherein:
the auscultation device and the processor are components of a mechanical chest compression device, the mechanical chest compression device comprising a chest compressing mechanism configured to be disposed on the chest and to administer the chest compressions to the subject; and
the feedback instructs a rescuer to change the position on the chest at which of the chest compressing mechanism is disposed.

10. The CPR system of claim 9, wherein:
the chest compressing mechanism comprises a piston;
the mechanical chest compression device further comprises a backplate configured to be disposed under a back of the subject; and
the auscultation device is disposed on:
a distal end of the piston that is configured to contact the chest; or
an inner surface of the backplate that is configured to contact the back.

11. The CPR system of claim 9, wherein:
the processor is further configured to cause, during a compression phase of a compression-decompression cycle, the chest compressing mechanism to move from a first position to a second position that represents a target compression depth; and
cause the auscultation device to detect a heart sound in response to the chest compressing mechanism arriving at the second position.

12. The CPR system of claim 8, wherein:
the auscultation device is a component of a CPR feedback device that is configured to be disposed on the chest; and
the feedback instructs a rescuer to change the position on the chest at which hands of the rescuer are placed for manually administering the chest compressions.

13. The CPR system of claim 12, wherein the auscultation device is disposed on an inner surface of the CPR feedback device that is configured to contact the chest.

14. The CPR system of claim 6, wherein the feedback signal is output as an audible signal, a visual signal, or a haptic signal.

15. The CPR system of claim 8, wherein:
the CPR system further comprises a microphone configured to detect a sound in an environment where the CPR system is located while the chest compressions are being administered to the subject; and
the processor is further configured to perform active-noise-cancellation (ANC) to remove the sound in the environment detected by the auscultation device.

16. The CPR system of claim 6, wherein determining that the heart valve of the subject is not functioning comprises determining that an aortic valve or a pulmonary valve of a heart of the subject closed incompletely during a compression phase of a compression-decompression cycle.

17. A method comprising:
receiving, by a processor of a cardiopulmonary resuscitation (CPR) system, a parameter associated with a subject and sensed by sensor of the CPR system during administration of chest compressions to the subject;
determining, by the processor, and by analyzing the parameter sensed by the sensor, that a heart valve of the subject is not functioning; and
in response to determining that the heart valve of the subject is not functioning, causing, by the processor, a feedback signal to be output as feedback to change a position on a chest of the subject at which future chest compressions are to be administered to the subject.

18. The method of claim 17, wherein the sensor is an auscultation device configured to be disposed on a thorax of the subject.

19. The method of claim 18, wherein the auscultation device and the processor are components of a mechanical chest compression device, the method further comprising:
causing, by the processor, a chest compressing mechanism of the mechanical chest compression device to move during a compression phase of a compression-decompression cycle; and
causing, by the processor, the auscultation device to detect a heart sound in response to determining an expiration of a predetermined amount of time since a start of the compression phase.

20. The method of claim 17, further comprising:
determining, by the processor, that a compression depth parameter associated with the chest compressions is within a first target value range; and
determining, by the processor, that a compression rate parameter associated with the chest compressions is within a second target value range,
wherein causing the feedback signal to be output is further in response to determining that the compression depth parameter is within the first target value range and that the compression rate parameter is within the second target value range.
